(19) United States
(12) Patent Application Publication
(10) Pub. No.: US 2002/0128852 A1
(43) Pub. Date: Sep. 12, 2002

(54) System and method for rendering legal services over the internet

(76) Inventor: Richard S. Draughon, Ponte Vedra Beach, FL (US)

Correspondence Address: DRAUGHON PROFESSIONAL ASSOCIATION, ONE INDEPENDENT DRIVE, SUITE 2000, JACKSONVILLE, FL, 32202, US

(21) Appl. No.: 09/820,031

(22) Filed: Mar. 28, 2001

Related U.S. Application Data
(60) Provisional application No. 60/273,032, filed on Mar. 1, 2001.

(51) Int. Cl. G06F 17/60

(52) U.S. Cl. 705/1

(57) ABSTRACT

A method and system for rendering legal services on-line using a hierarchical arrangement of sections, libraries, sublibraries and legal forms; streaming instructional videos concerning the sections, libraries, sublibraries and legal forms; and commentary concerning the sections, libraries, sublibraries and legal forms; are disclosed. In a preferred embodiment, the disclosed method and system employs an on-line template for requesting legal consultations, and an on-line arbitration system.

### BACKGROUND

This application claims the benefit of U.S. Provisional Application, Serial No. 60/273,032 entitled System and Method for Rendering Legal Services Over the Internet, filed with the U.S. Patent and Trademark Office on Mar. 1, 2001.

This invention relates to a system and method for rendering legal services on-line, preferably over the Internet.

Entrepreneurs and businesses require legal services to manage their legal affairs, the cost of which can be staggering. While large corporations can afford extensive legal representation and manage in-house or outside counsel, individuals and small businesses, including start-ups, often do not have a significant budget for legal services. Consequently, some of their legal work may simply go undone, or be handled by uninitiated members of their staff, substantially increasing the entity's risk profile and potentially compromising the entity's rights.

Budgetary limitations are not the only impediment to obtaining legal representation for small businesses and entrepreneurs. Based upon prevailing societal prejudices, many people are wary of lawyers. Some have grown distrustful of attorneys, having had unpleasant and costly past experiences. They would prefer to manage their own legal affairs, but, until now, lacked the resources to do so.

Junior lawyers at law firms and corporations require similar resources for managing legal affairs. They need significant guidance and training to operate effectively. Senior attorneys often prefer to focus on billable activities, rather than provide the junior attorney the necessary structured guidance and training. While large organizations can afford to devote staff to provide orientation and tutorials, many small organizations cannot afford to do the same. In such situations, both the organization and junior attorney suffer. Failing to provide the necessary guidance and training substantially compromises the junior attorney's chances of operating effectively.

While do-it-yourself books, software and forms libraries have emerged to capitalize on the need for low-cost self-help legal solutions, these tools typically do not provide sufficient information and guidance as well as a structured framework needed for the uninitiated to intelligently select the best legal form as a starting point, understand its application and correctly complete it. Many such tools offer forms tailored in favor of only one side of a transaction (e.g., buyer), or not tailored in favor of either side, potentially compromising the legal interests of the user. Geared for experienced lawyers, many such tools skip introductory materials and use arcane legal jargon, making them incomprehensible to the layperson and inexperienced attorney.

Until now, there existed an unfulfilled need for a system, such as that provided through Applicant's MyTechnologyLawyer website at www.mytechnologylawyer.com, comprised of on-line interactive resources for managing legal affairs. These resources help entrepreneurs, executives, their lawyers and junior attorneys to independently prepare necessary agreements, negotiate transactions, obtain focused legal consultations, evaluate disputes, resolve disputes and, if necessary, retain legal counsel. These resources, comprising an implementation of the subject invention, help reduce legal fees and legal risks while providing a structured framework for engaging counsel, as necessary.

### SUMMARY

The present invention provides a system and method for providing on-line interactive resources for managing legal affairs. The system includes legal forms as well as dispute resolution, case review and consultation tools. It also includes administrative tools to manage and enhance the system.

An object of the invention is to provide a collection of forms for businesses and individuals to use for managing their legal affairs.

Another object of the invention is to provide a hierarchical arrangement of libraries, sub-libraries and forms organized to guide a user to the best form to adopt as a starting point.

Another object of the invention is to provide written and video commentary and instruction at each level of the hierarchy.

Another object of the invention is to provide different versions of form agreements drafted in favor of each side of a transaction (e.g., a licensor-oriented software license agreement and a licensee-oriented software license agreement).

Another object of the invention is to provide statistics to shed light on the complexity of a form.

Another object of the invention is to provide the ability for a user to buy a subscription to a library or sub-library, or pay for a single form.

Another object of the invention is to provide a graphical directory tree to facilitate navigating through libraries and sub-libraries.

Another object of the invention is to provide forms in a popular format that is editable by the user with standard word processing software.

Another object of the invention is to provide terms and conditions with every downloaded form to clearly document the user's legal rights.

Another object of the invention is to provide revision controls that save each version of the terms and conditions and record the version number of the terms and conditions that accompanied each downloaded form.

Another object of the invention is to provide tools for alternative dispute resolution.

Another object of the invention is to provide a hierarchical arrangement of alternative dispute resolution topics to educate the user.

Another object of the invention is to provide alternative dispute resolution rules that parties may adopt to resolve their disputes.

Another object of the invention is to provide access to a body of eligible arbitrators and mediators that parties may select to resolve a dispute.

Another object of the invention is to provide templates, instructions and procedures for conducting arbitrations on-line.

Another object of the invention is to provide a library of frequently asked questions.

Another object of the invention is to provide a template for requesting a consultation of certain duration with an attorney concerning an issue pre-defined by the user at a specified hourly rate.

Another object of the invention is to provide a template for requesting answers to questions at no charge.

Another object of the invention is to provide a template for submitting case specifics for review by an attorney.

Another object of the invention is to provide administrative tools for managing the system of the subject invention.

Yet, another object of the invention is to provide a template for conveniently adding libraries, sub-libraries and forms.

Still another object of the invention is to provide tools for managing client account information.

An additional object of the invention is to provide a system map.

### DRAWINGS

These and other features, aspects and advantages of the present invention will become better understood with reference to the following description, accompanying drawings and claims.

FIG. 1 depicts an introduction (“who is”) section of a system in accordance with an embodiment of the subject invention.

FIG. 2 depicts a page including contact information in accordance with an embodiment of the subject invention.

FIG. 3 depicts a legal forms section page of a system in accordance with an embodiment of the subject invention.

FIG. 4 depicts a subscription purchase link of a system in accordance with an embodiment of the subject invention.

FIG. 5 depicts a software library page of a system in accordance with an embodiment of the subject invention.

FIG. 6 depicts a software license sublibrary page of a system in accordance with an embodiment of the subject invention.

FIG. 7 depicts a software license form (favors licensee) page of a system in accordance with an embodiment of the subject invention.

FIG. 8 depicts a software license form (favors licensee) page and form statistics for a system in accordance with an embodiment of the subject invention.

FIG. 9 depicts a first subscription purchasing page of a system in accordance with an embodiment of the subject invention.

FIG. 10 depicts a second subscription purchasing page of a system in accordance with an embodiment of the subject invention.

FIG. 11 depicts a purchase agreement page of a system in accordance with an embodiment of the subject invention.

FIG. 12 depicts a third subscription purchasing page of a system in accordance with an embodiment of the subject invention.

FIG. 13 depicts a fourth subscription purchasing page of a system in accordance with an embodiment of the subject invention.

FIG. 14 depicts a dispute resolution section page of a system in accordance with an embodiment of the subject invention.

FIG. 15 depicts an arbitration library page of a system in accordance with an embodiment of the subject invention.

FIG. 16 depicts an arbitration agreements sublibrary page of a system in accordance with an embodiment of the subject invention.

FIG. 17 depicts an arbitration agreement page of a system in accordance with an embodiment of the subject invention.

FIG. 18 depicts an arbitration request sublibrary page of a system in accordance with an embodiment of the subject invention.

FIG. 19 depicts a demand for arbitration page of a system in accordance with an embodiment of the subject invention.

FIG. 20 depicts an arbitration administrative issues page of a system in accordance with an embodiment of the subject invention.

FIG. 21 depicts a location of hearing page of a system in accordance with an embodiment of the subject invention.

FIG. 22 depicts an arbitration fee schedule page of a system in accordance with an embodiment of the subject invention.

FIG. 23 depicts a rules of arbitration sublibrary page of a system in accordance with an embodiment of the subject invention.

FIG. 24 depicts an arbitrator selection sublibrary page of a system in accordance with an embodiment of the subject invention.

FIG. 25 depicts a mediation library page of a system in accordance with an embodiment of the subject invention.

FIG. 26 depicts a mediation agreements sublibrary page of a system in accordance with an embodiment of the subject invention.

FIG. 27 depicts a mediation agreement page of a system in accordance with an embodiment of the subject invention.

FIG. 28 depicts a mediation request sublibrary page of a system in accordance with an embodiment of the subject invention.

FIG. 29 depicts a request for mediation page of a system in accordance with an embodiment of the subject invention.

FIG. 30 depicts a mediation administrative issues page of a system in accordance with an embodiment of the subject invention.

FIG. 31 depicts a location of hearing page of a system in accordance with an embodiment of the subject invention.

FIG. 32 depicts a mediation fee schedule page of a system in accordance with an embodiment of the subject invention.

FIG. 33 depicts a rules of mediation sublibrary page of a system in accordance with an embodiment of the subject invention.

FIG. 34 depicts a mediator selection sublibrary page of a system in accordance with an embodiment of the subject invention.

FIG. 35 depicts an arbitrators/mediators sublibrary page of a system in accordance with an embodiment of the subject invention.

FIG. 36 depicts an arbitrator/mediator page of a system in accordance with an embodiment of the subject invention.

FIG. 37 depicts a case review section page of a system in accordance with an embodiment of the subject invention.

FIG. 38 depicts a request a review sublibrary page of a system in accordance with an embodiment of the subject invention.

FIG. 39 depicts a first case review request page of a system in accordance with an embodiment of the subject invention.

FIG. 40 depicts a second case review request page of a system in accordance with an embodiment of the subject invention.

FIG. 41 depicts a third case review request page of a system in accordance with an embodiment of the subject invention.

FIG. 42 depicts a consultations section page of a system in accordance with an embodiment of the subject invention.

FIG. 43 depicts an educational video library section of a system in accordance with an embodiment of the subject invention.

FIG. 44 depicts a common questions library page of a system in accordance with an embodiment of the subject invention.

FIG. 45 depicts a request a consultation library of a system in accordance with an embodiment of the subject invention.

FIG. 46 depicts a first consultation request page of a system in accordance with an embodiment of the subject invention.

FIG. 47 depicts a second consultation request page of a system in accordance with an embodiment of the subject invention.

FIG. 48 depicts a third consultation request page of a system in accordance with an embodiment of the subject invention.

FIG. 49 depicts a fourth consultation request page of a system in accordance with an embodiment of the subject invention.

FIG. 50 depicts a submit a question library of a system in accordance with an embodiment of the subject invention.

FIG. 51 depicts a first question submittal page of a system in accordance with an embodiment of the subject invention.

FIG. 52 depicts a second question submittal page of a system in accordance with an embodiment of the subject invention.

FIG. 53 depicts a third question submittal page of a system in accordance with an embodiment of the subject invention.

FIG. 54 depicts an administration sign-on page of a system in accordance with an embodiment of the subject invention.

FIG. 55 depicts a system map page of a system in accordance with an embodiment of the subject invention.

FIG. 56 depicts a page of a template for editing a library of a system in accordance with an embodiment of the subject invention.

FIG. 57 depicts a page of a template for editing a sublibrary of a system in accordance with an embodiment of the subject invention.

FIG. 58 depicts a first page of a template for editing information related to a form of a system in accordance with an embodiment of the subject invention.

FIG. 59 depicts a second page of a template for editing information related to a form of a system in accordance with an embodiment of the subject invention.

FIG. 60 depicts a system map page with a menu of links to administrative tools of a system in accordance with an embodiment of the subject invention.

FIG. 61 depicts a page of a template for adding a library to a system in accordance with an embodiment of the subject invention.

FIG. 62 depicts a page of a template for editing purchasing terms and conditions of a system in accordance with an embodiment of the subject invention.

### DETAILED DESCRIPTION

The invention summarized above and exemplified by the attached drawings may be better understood by referring to the following detailed description and claims. This detailed description of a particular preferred embodiment, set out below to enable one to practice the invention, is not intended to limit the scope of the invention, but to serve as a particular example thereof. Those skilled in the art should appreciate that they can readily use the concepts and specific embodiment disclosed as a basis for modifying or designing other methods and systems for carrying out the same purposes of the present invention. For example, the preferred embodiments set forth below could apply to any area of law, not only technology law. Those skilled in the art should also realize that such equivalent methods and systems do not depart from the spirit and scope of the invention.

The term user, as employed herein, means an individual utilizing the system of the subject invention to manage legal affairs. The term subscriber, as employed herein, means a user who may access legal forms on the system. The term template, as employed herein, refers to any means for providing information, including predefined forms having blank spaces for completion by a user.

The system of the present invention is implemented for on-line user access over a computer network, preferably the Internet and particularly the World Wide Web, using prevailing Internet access and browser software, such as Microsoft's Windows operating system and either Netscape Navigator or Microsoft's Internet Explorer browser. The system may also be implemented on local area networks, wide area networks, intranets and computers providing direct dial-up access to users. The system may include HTML, scripts (e.g., JAVA and VB), cgi applications, activeX data objects, applets, database software, databases and the like.

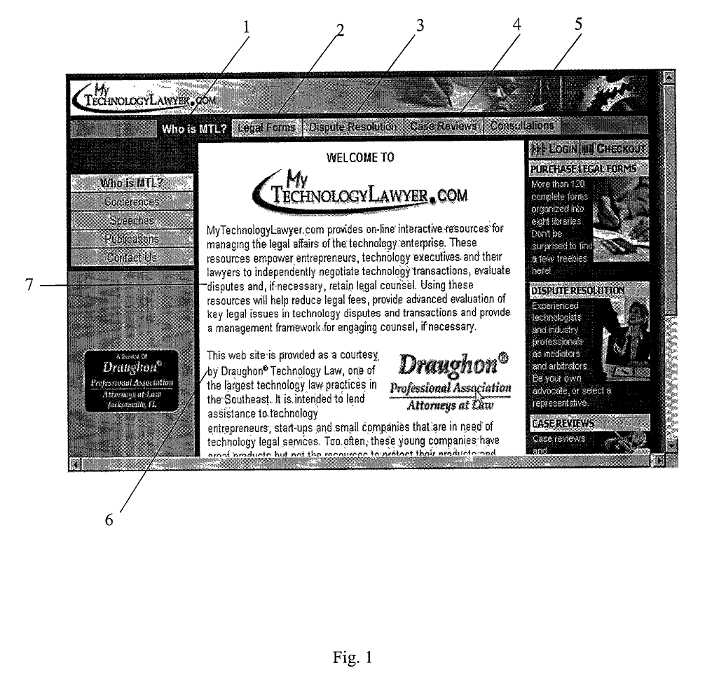

Preferably, the system is divided into discrete intuitive sections to facilitate administration as well as user navigation. For example, referring to FIG. 1, the system may include the following sections: Introduction (“Who is”) 1, Legal Forms 2, Dispute Resolution 3, Case Reviews 4, and Consultations 5 sections.

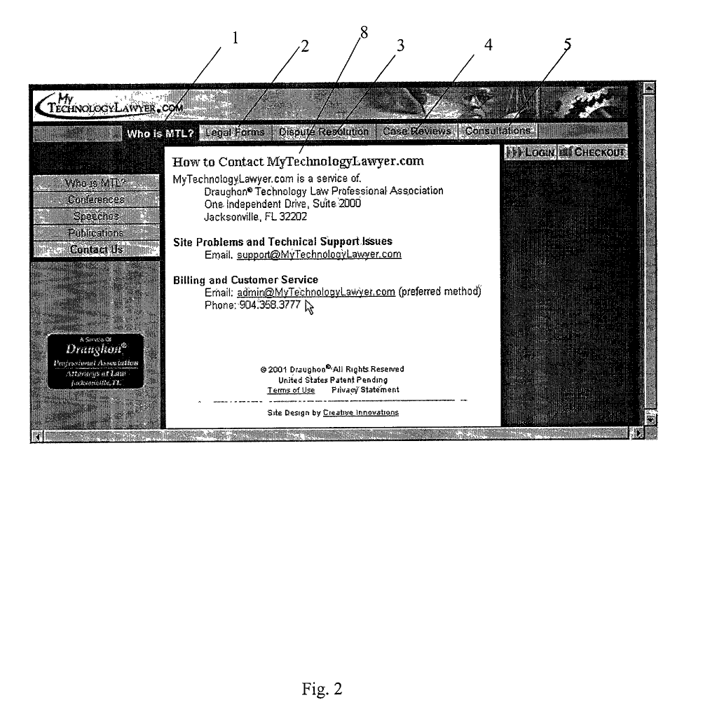

The Introduction section, accessed by selecting a “Who is” link 1, provides information concerning the sponsor 6 of the system and the scope of coverage 7, as in FIG. 1. Savvy users will seek information concerning the professional experience, credentials and any potential biases of the sponsor. A sponsor's expertise will inspire confidence. The system should also preferably provide contact information 8, as in FIG. 2.

The Legal Forms section, accessed by selecting a corresponding link 2, provides legal forms covering a wide array of subjects and transactions. Many of the forms favor one party to a transaction over the other party to a transaction. For example, a licensee-oriented software license form would contain broad warranties, whereas a licensor-oriented software license form would contain a very limited warranty and broad warranty disclaimers.

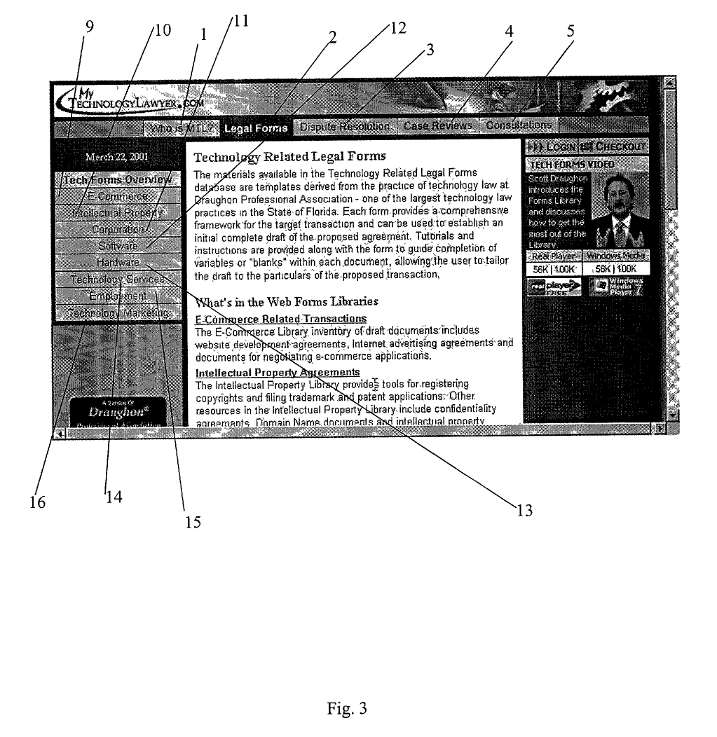

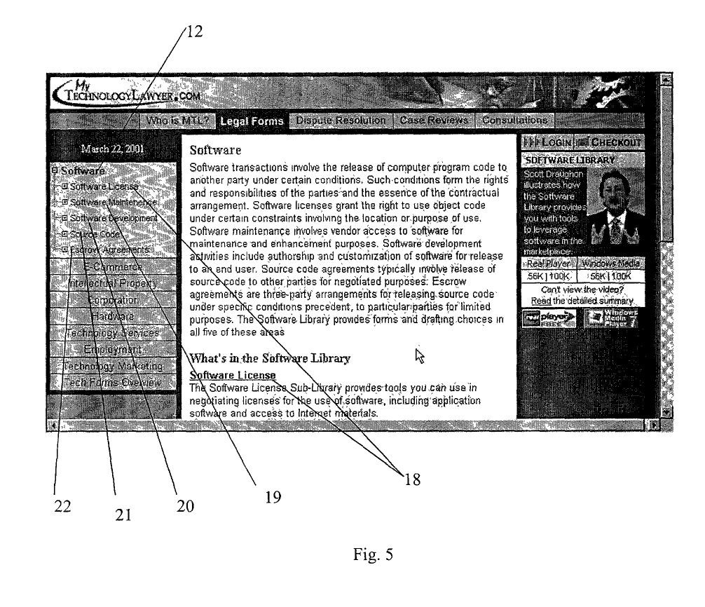

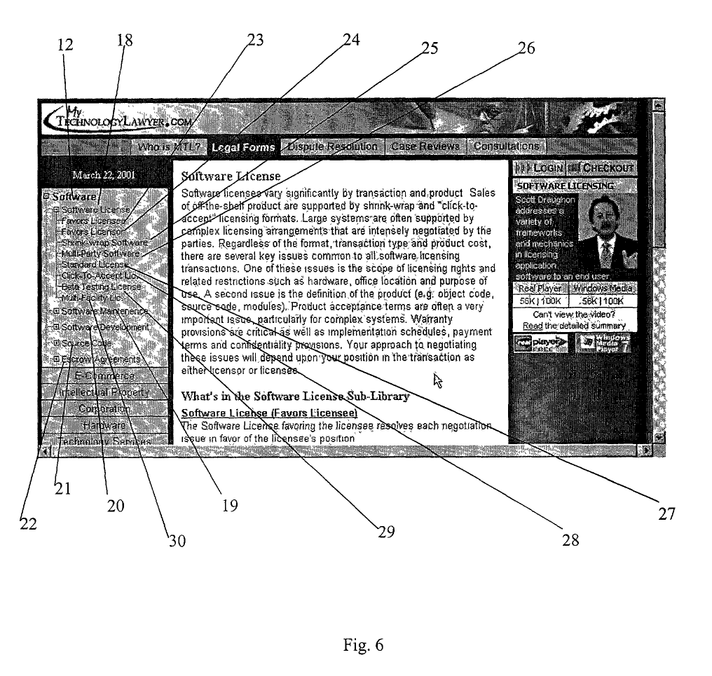

The Legal Forms section includes a hierarchy of libraries and sub-libraries that users may access by selecting corresponding links, such as the tabs shown at the top of FIG. 3. The forms are organized in a hierarchy of libraries and sub-libraries to facilitate user navigation. Each library covers a legal topic and provides access to sublibraries and/or forms. Sublibraries cover an aspect of the legal topic and provide access to additional sublibraries or forms. For a narrow legal topic or a legal topic for which there are relatively few forms, libraries may omit sublibraries and provide access directly to the legal forms. For illustrative purposes, FIG. 3 displays the following technology related legal forms libraries: E-Commerce Related Transactions 9, Intellectual Property Agreements 10, Corporation Related 11, Software 12, Hardware 13, Technology Services 14, Employment Agreements 15, and Technology Marketing Agreements 16. The Software library, as shown in FIG. 5, includes the following sub-libraries: Software License 18, Software Maintenance 19, Software Development 20, Source Code Agreements 21 and Escrow Agreements 22. The Software License sub-library, as shown in FIG. 6, includes the following forms: Software License (Favoring Licensee) 23, Software License (Favoring Licensor) 24, Shrink-wrap Software License 25, Multi-Party Software License 26, Software License (Standard Terms) 27, Click-To-Accept License 28, Beta Testing Software License 29 and a Multi-Facility Software License 30.

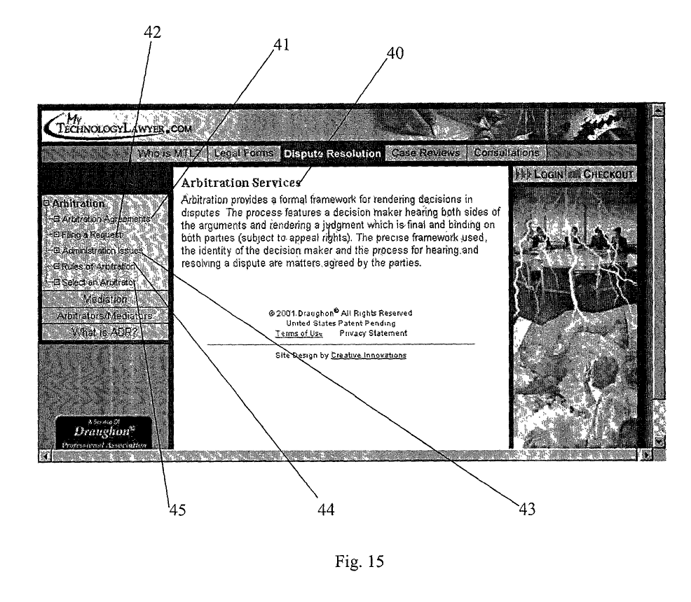

FIGS. 15 through 23 graphically display this hierarchical arrangement of libraries, sub-libraries and forms. A similar hierarchical arrangement of sub-libraries and forms exists for each library.

At each level of the hierarchy, the system preferably provides written information, i.e., commentary, and a video presentation on the selected topic or form. The written commentary and video provide information designed to help a user navigate through the libraries and sub-libraries, select the best form to use as a starting point for a particular transaction, understand the issues involved and learn how to complete the form. For example, referring to FIG. 3, the system includes commentary and a streaming video presentation on Technology Related Legal Forms. The commentary and presentation guide a user by discussing the available libraries and sublibraries. Referring to FIG. 5, the system includes commentary and a streaming video presentation for the Software library. The commentary and presentation guide a user by discussing the available sublibraries. Referring to FIG. 6, the system includes commentary and a streaming video presentation on Software Licensing. The commentary and presentation guides a user by discussing the available Software Licensing forms. In a preferred embodiment, the system also includes commentary and a streaming video presentation on each available form. A user may view a video by selecting it using a browser equipped with a compatible streaming video plug-in.

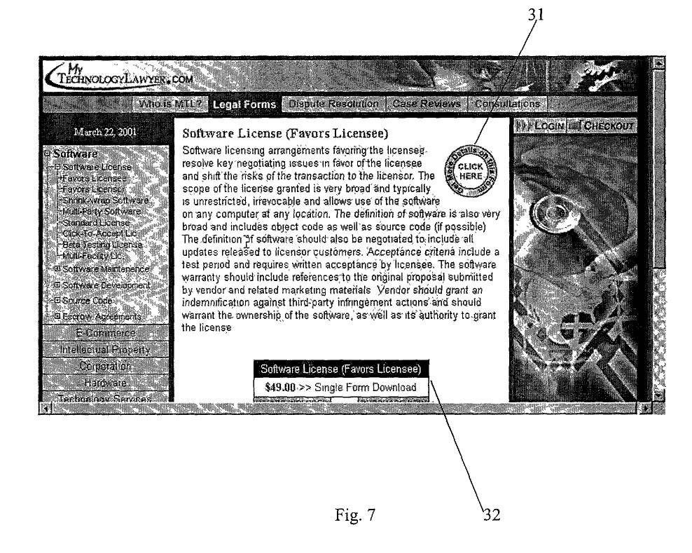

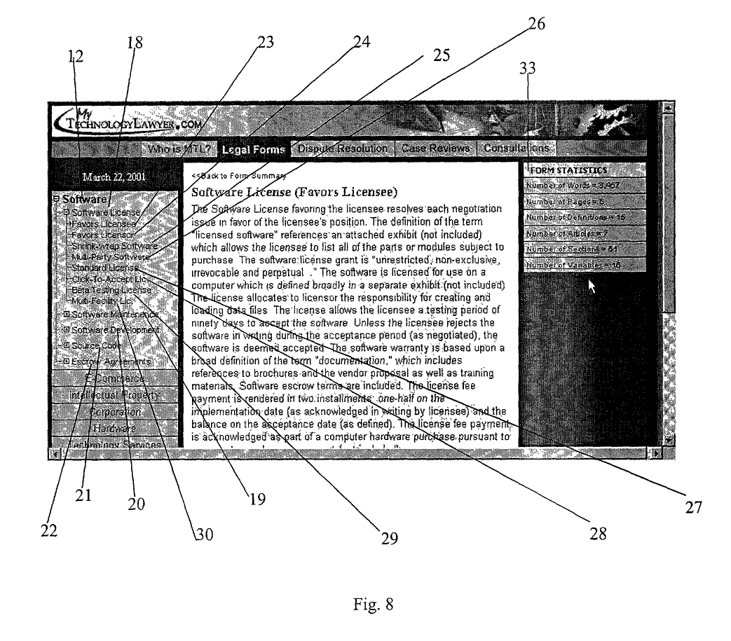

The system includes form statistics to shed light on the complexity of the form. The statistics may include the number of words, pages, definitions, articles, sections and variables. By selecting the Get More Details button 31, FIG. 7, a user accesses the form statistics 33 for the selected form, FIG. 8. Upon reviewing the form statistics 33, a user can estimate the level of effort required to complete the form before purchasing it.

A graphical hierarchical tree facilitates navigation. Not only does the tree reveal the user's current location, it provides a means for quickly jumping to a new location by selecting the desired tree element. Referring to the top left of FIG. 3, the tree reveals the E-Commerce Related Transactions 9, Intellectual Property Agreements 10, Corporation Related 11, Software 12, Hardware 13, Technology Services 14, Employment Agreements 15, and Technology Marketing Agreements 16 libraries. Referring to FIG. 5, the tree displays the Software library 12, as well as the Software License 18, Software Maintenance 19, Software Development 20, Source Code Agreements 21 and Escrow Agreements 22 sub-libraries. Referring to FIG. 6, the tree displays the Software library 12 and its sub-libraries 18-22, as well as the Software License (Favoring Licensee) 23, Software License (Favoring Licensor) 24, Shrink-wrap Software License 25, Multi-Party Software License 26, Software License (Standard Terms) 27, Click-To-Accept License 28, Beta Testing Software License 29 and Multi-Facility Software License 30 forms, under the Software License sub-library 18. Referring to FIG. 8, the tree displays the Software library 12 and its sub-libraries 18-22, as well as the Software License (Favoring Licensee) 23, Software License (Favoring Licensor) 24, Shrink-wrap Software License 25, Multi-Party Software License 26, Software License (Standard Terms) 27, Click-To-Accept License 28, Beta Testing Software License 29 and Multi-Facility Software License 30 forms, under the Software License sub-library 18, with the selected form (i.e., the Software License (Favoring Licensee) form 23) highlighted.

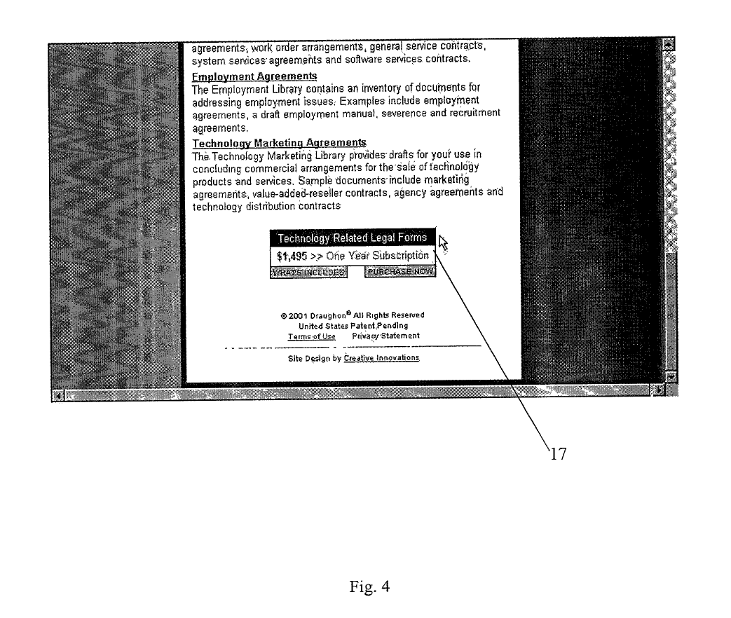

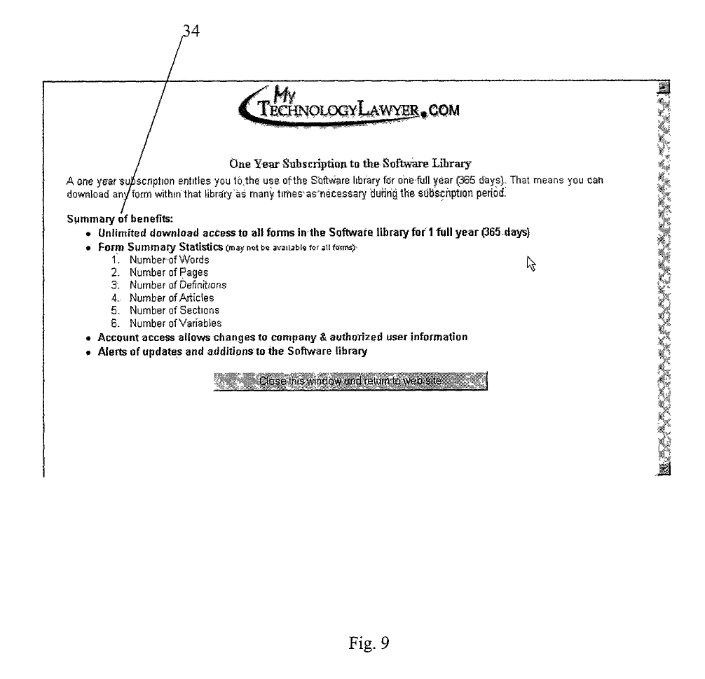

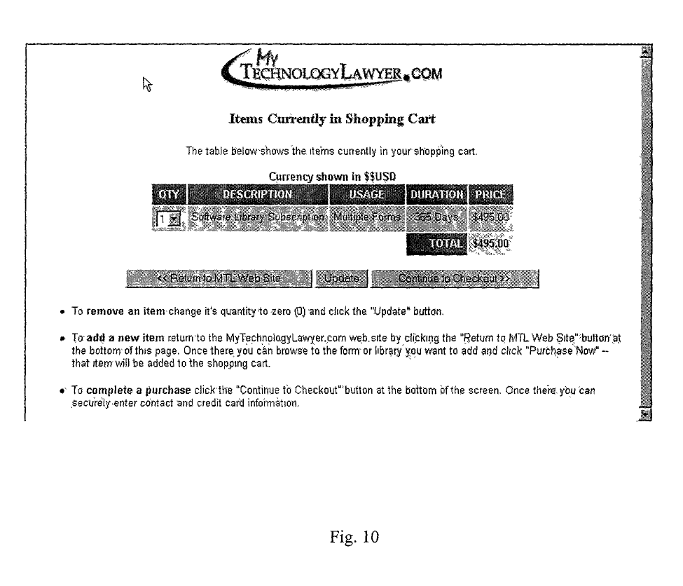

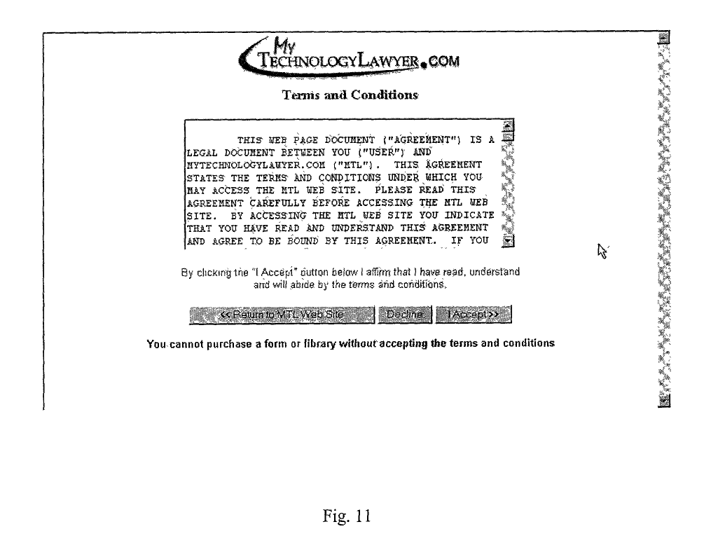

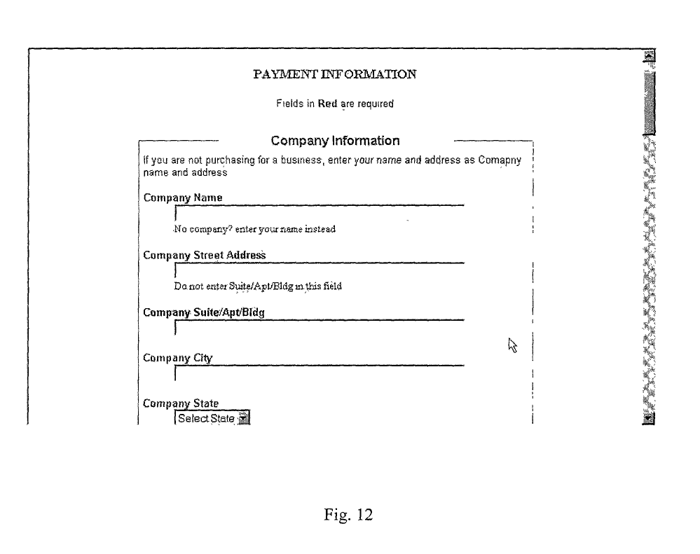

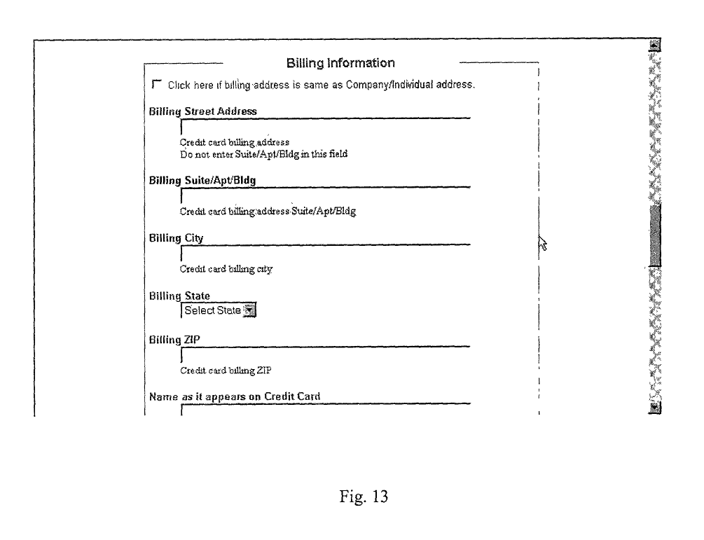

The system provides pricing information and purchasing links at various levels of the hierarchy. For example, at the bottom of the technology related legal forms screen, FIG. 4, the system provides pricing information 17 for a subscription to all the libraries listed. Similarly, he system may provide pricing information for a subscription to each individual library and pricing information 32 for an individual form, FIG. 7. The system may also provide pricing information for a subscription to each sub-library. The pricing information includes details concerning the benefits 34 of the priced subscription, FIG. 9. A subscription may provide a subscriber access to legal forms for a specified duration, a certain number of times, or some combination. An adjacent link takes a user through a secure on-line purchasing sequence, presenting the user with an on-line shopping cart FIG. 10 and prompting the user for assent to the purchase terms FIG. 11, company information FIG. 12, billing information FIG. 13, contact information, and checkout confirmation. Systems designed exclusively for internal use by an organization may omit such pricing information and purchasing links.

Preferably, the system includes revision control for the purchase terms FIG. 11. Each version of the purchase terms and conditions, to which a user must assent to complete a purchase, is assigned a unique identification (“version number”). The system stores at least one copy of that version. Upon the completion of a purchase, the version number is stored along with the purchase information. Should a dispute subsequently arise in connection with the purchase, the system administrator could retrieve the purchase information and version number, and produce an exact copy of the accepted terms and conditions for determining the parties' rights and obligations.

The system preferably offers downloadable forms in a format readily accessible and modifiable by most users, e.g., Rich Text format. Other formats may be used as well, including (without limitation) HTML, MS Word, Corel WordPerfect, ASCII text, Adobe Acrobat (pdf). At a minimum, users will want to electronically fill blanks in the forms. Sophisticated users may wish to amend or modify the language of a form to suit their particular needs.

Some transactions will result in disagreement, no matter how carefully the parties drafted and negotiated the contract. Despite their best intentions, the parties may not be able to amicably resolve some disagreements. In such situations, users may need dispute resolution or case review services.

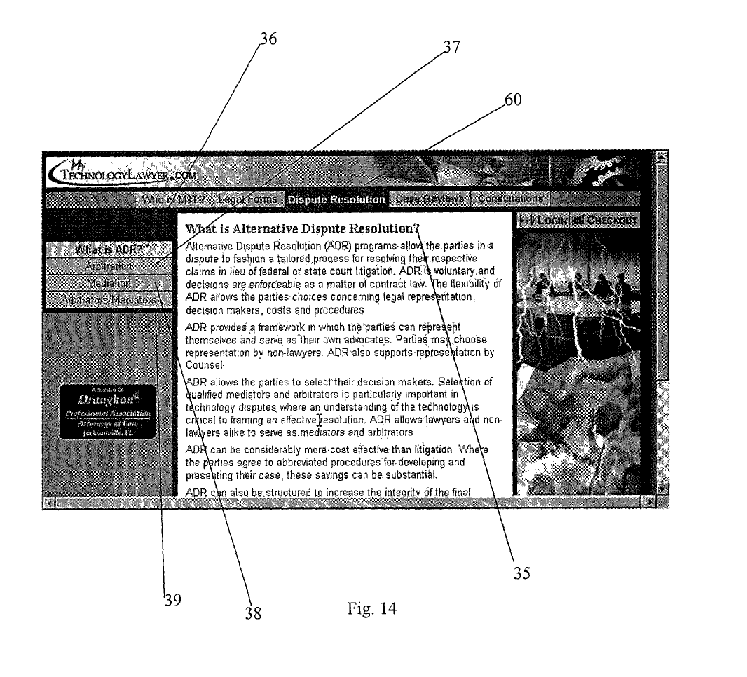

The Dispute Resolution section, accessed by selecting a corresponding link such as the tab 60 shown at the top of FIG. 14, includes a hierarchical arrangement of information, forms and guidance on alternative dispute resolution (“ADR”). At each level of the hierarchy, the system preferably provides written commentary and a video presentation on the selected topic or form. The written commentary and video provide information designed to help a user navigate through the libraries and sub-libraries, efficiently find information, select the best form to use as a starting point, understand the issues involved and learn how to proceed. For example, commentary 35 for a What is ADR library 36 for the Dispute Resolution section, as shown in FIG. 14, provides a brief overview of ADR. The hierarchy may include three libraries—an Arbitration library 37, a Mediation library 38 and Arbitrators/Mediators 39, i.e., a library of arbitrators and mediators that parties may select to resolve their disputes.

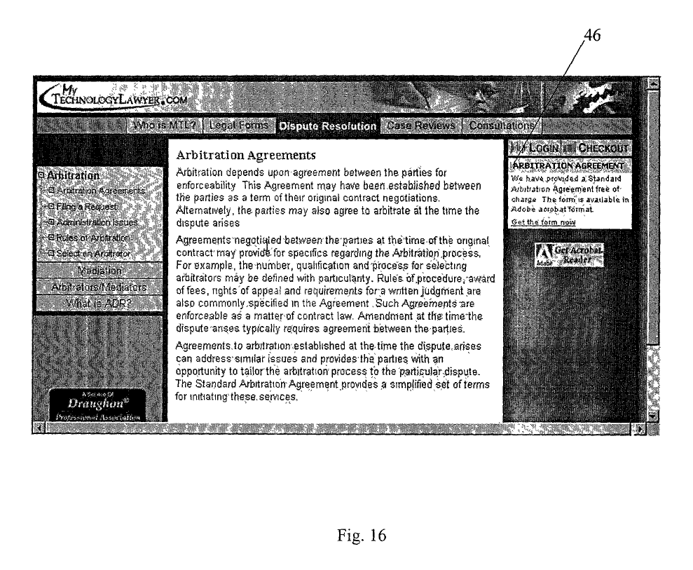

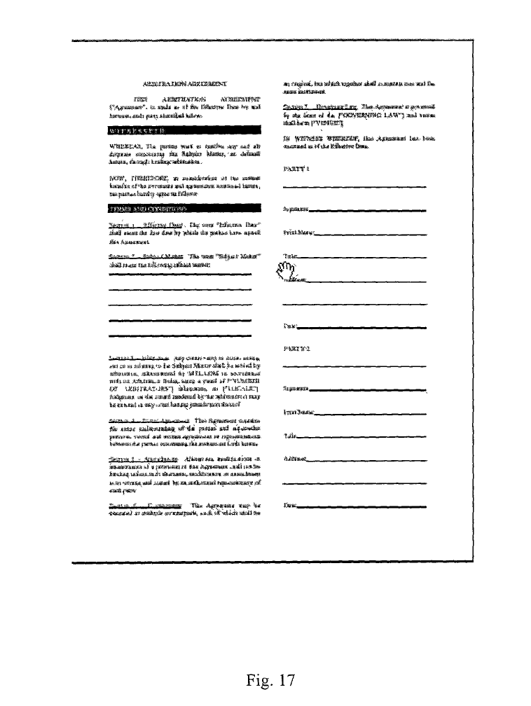

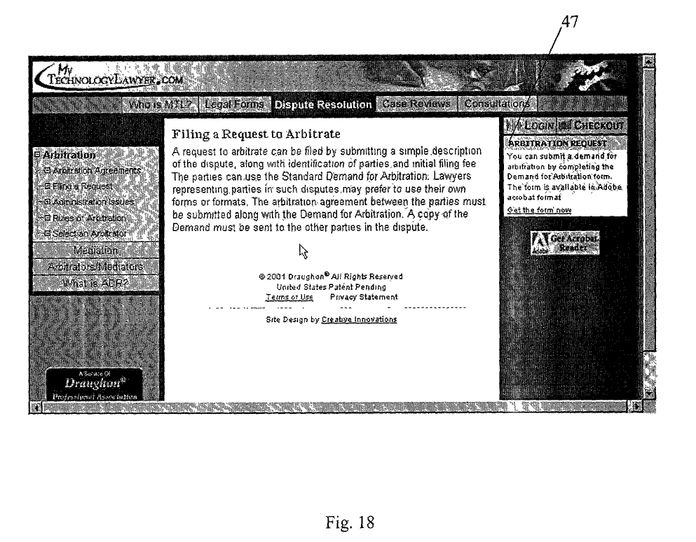

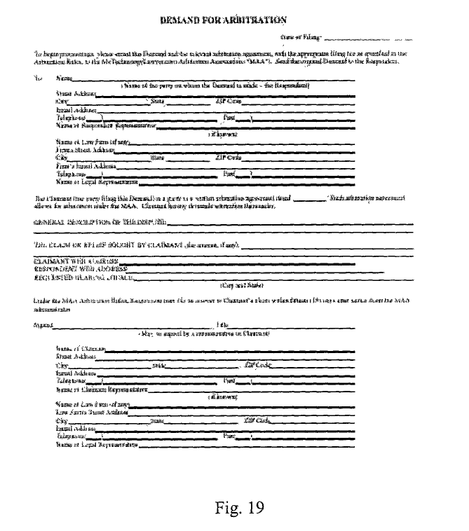

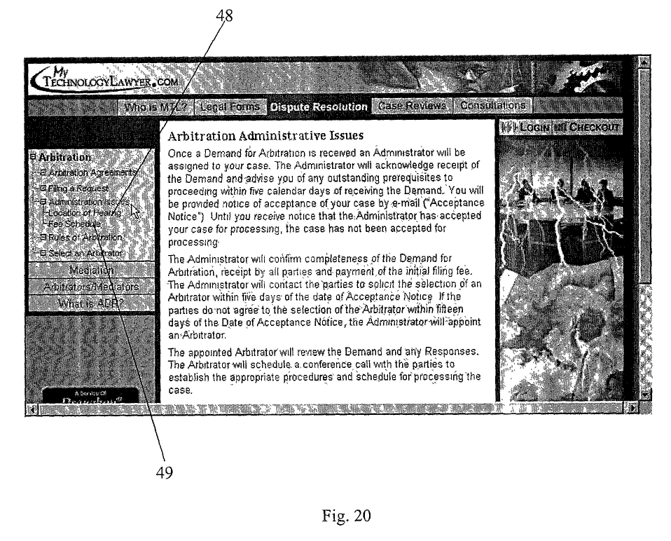

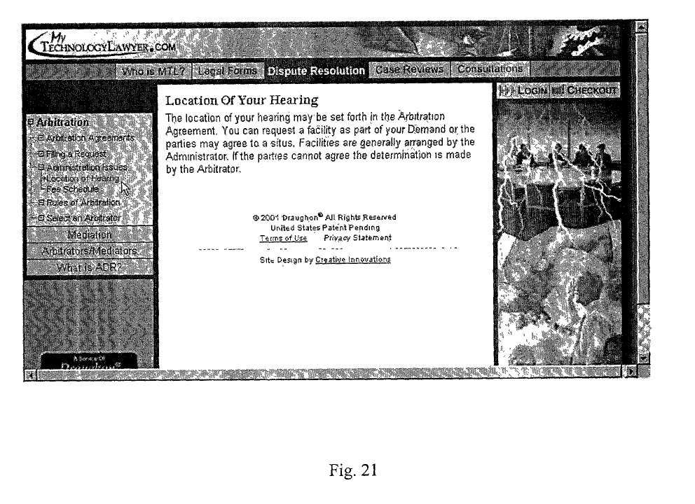

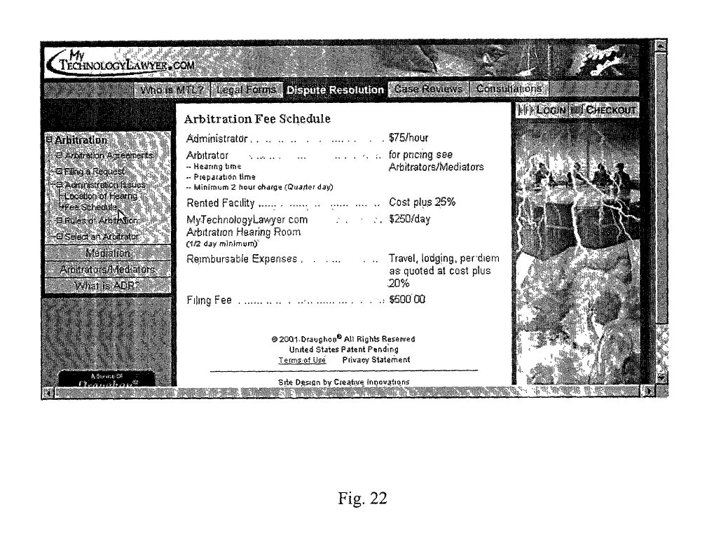

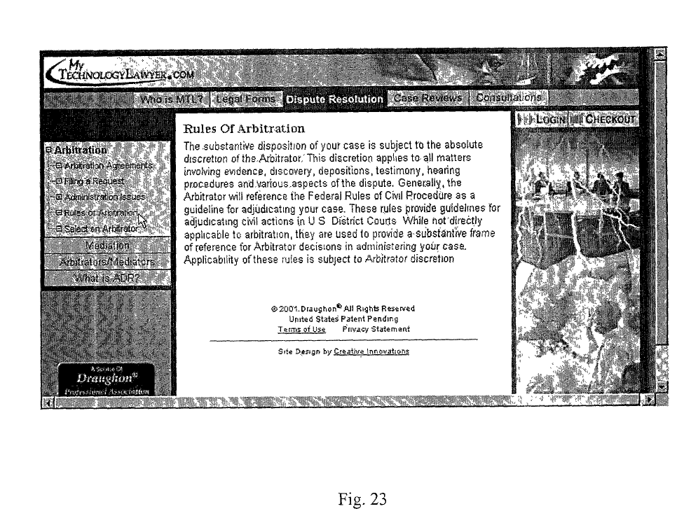

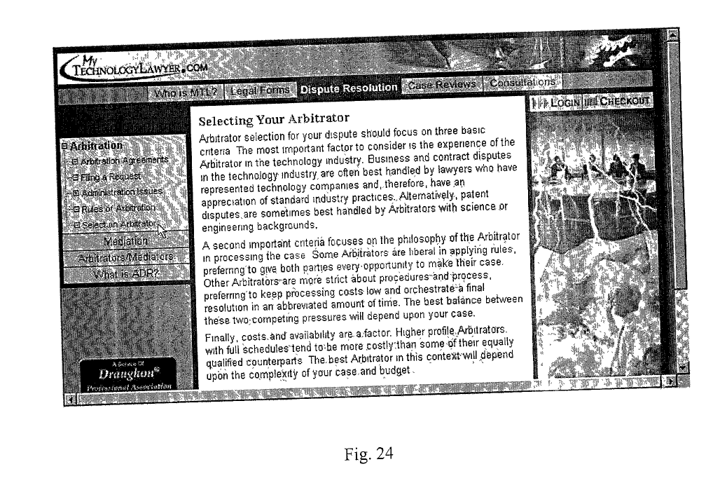

A user may access the Arbitration library 37 by selecting a corresponding link. Commentary 40 for the Arbitration library 37, as shown in FIG. 15, provides a brief overview of the arbitration process. Arbitration sub-libraries may include: Arbitration Agreements 41, Filing a Request 42, Administration Issues 43, Rules of Arbitration 44 and Select an Arbitrator 45. The Arbitration Agreements sublibrary FIG. 16 provides access to a form agreement 46, as shown in FIG. 17, that a user may employ to require arbitration of a dispute. The sublibrary preferably also provides written commentary and a video presentation concerning arbitration agreements. The Filing a Request sublibrary, as shown in FIG. 18, provides access to a form demand for arbitration 47, as shown in FIG. 19, that a user may employ to initiate arbitration. The sublibrary preferably also provides written commentary and a video presentation concerning the demand for arbitration. The Administration Issues sublibrary, as shown in FIG. 20, provides access to information concerning location of hearings 48, as shown in FIG. 21, and access to information concerning arbitration fees 49, as shown in FIG. 22. The Rules of Arbitration sublibrary provides access to the arbitration rules that a user may adopt to have disputes arbitrated through the system, as shown in FIG. 23. The sublibrary preferably also provides written commentary and a video presentation concerning the rules. The Select an Arbitrator sublibrary provides access to advice for selecting an arbitrator, as shown in FIG. 24. The sublibrary preferably also provides a video presentation concerning selection.

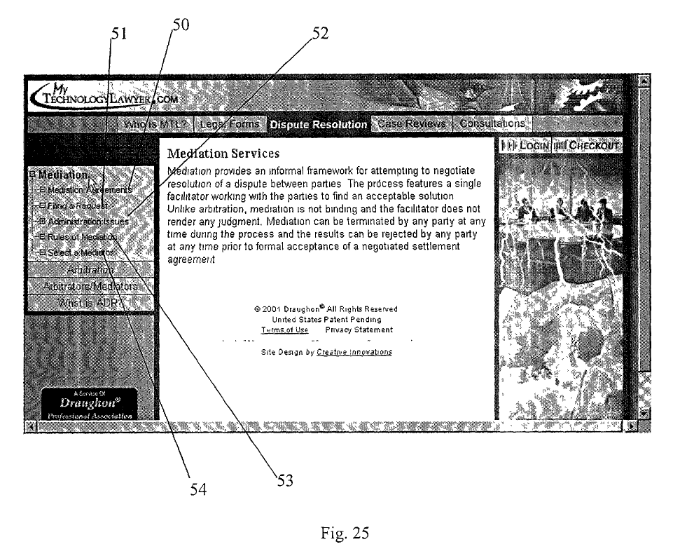

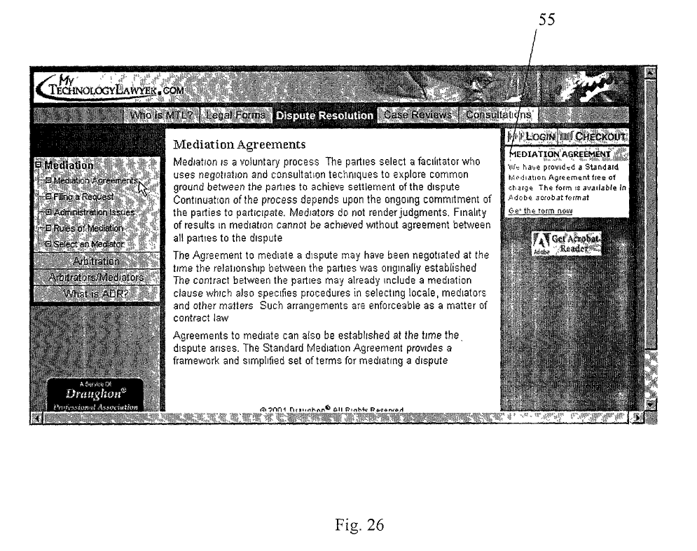

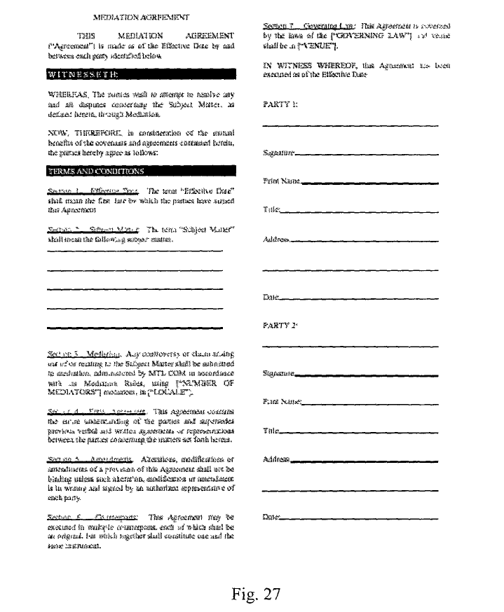

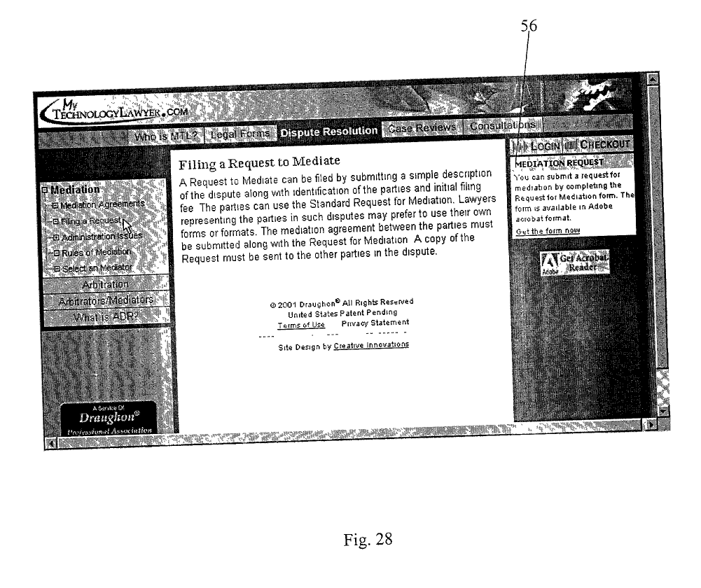

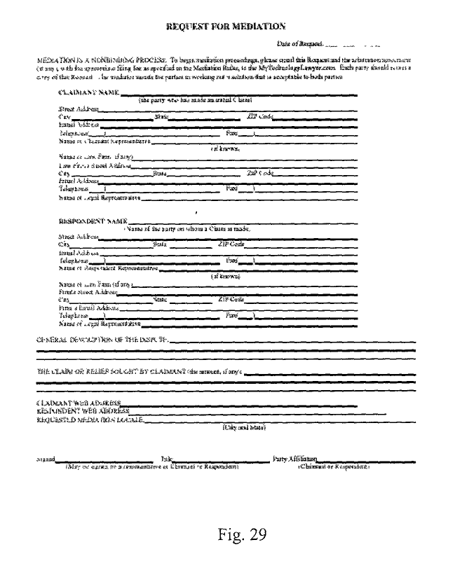

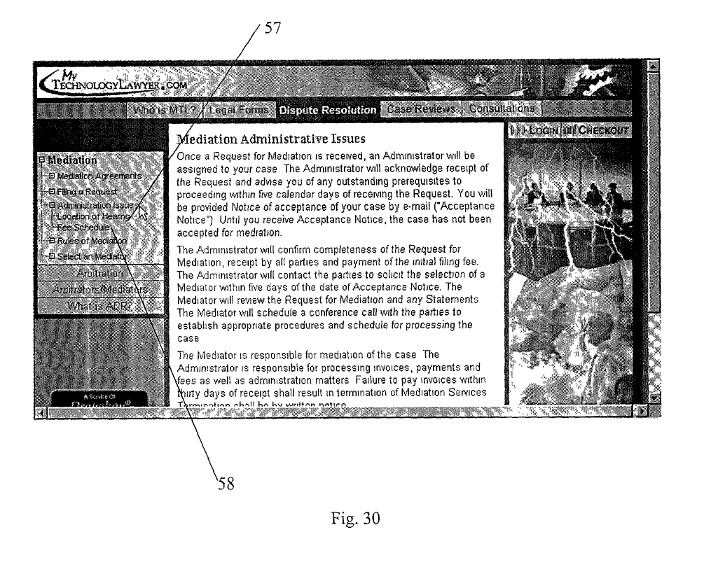

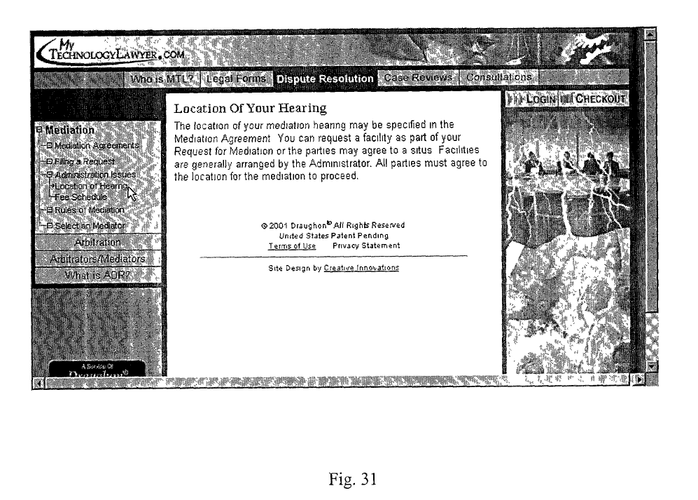

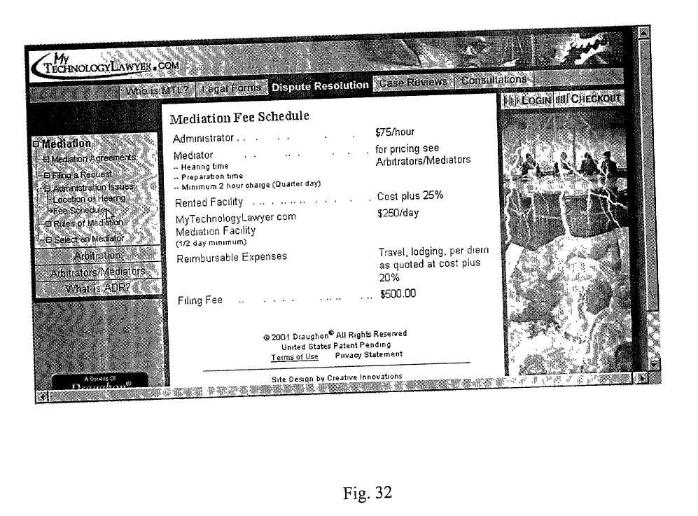

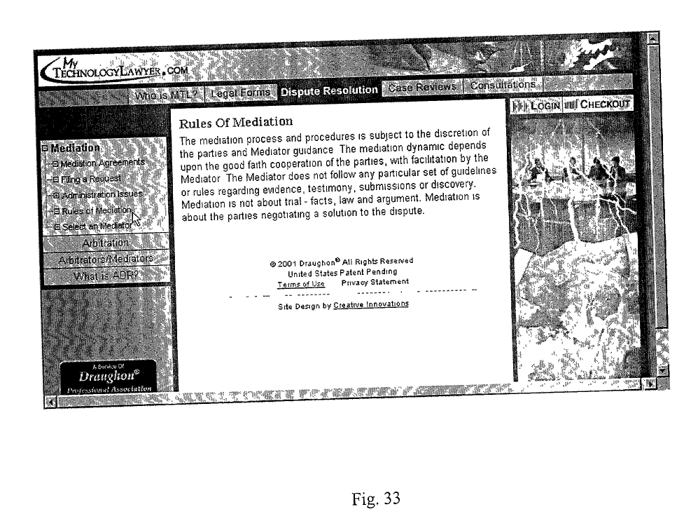

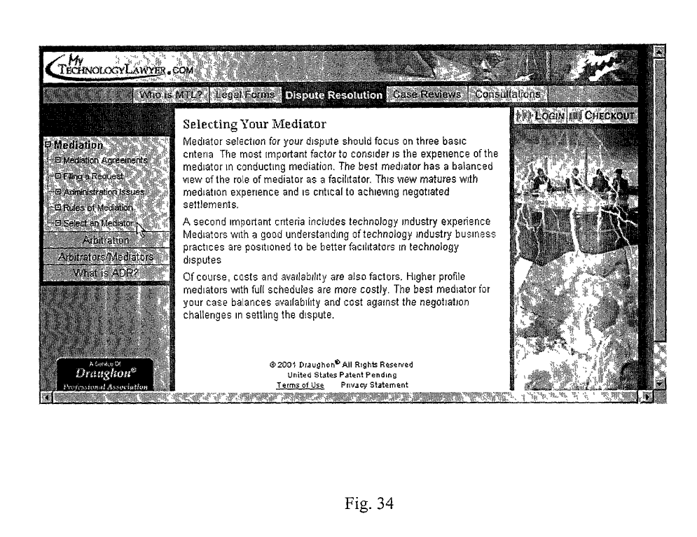

A user may access the Mediation library by selecting a corresponding link. Commentary for the Mediation library, as shown in FIG. 25, provides a brief overview of the mediation process. Mediation sub-libraries include: Mediation Agreements 50, Filing a Request 51, Administration Issues 52, Rules of Mediation 53, and Select a Mediator 54. The Mediation Agreements sublibrary, as shown in FIG. 26, provides access to a form agreement 55, as shown in FIG. 27, that a user may employ to require mediation of a dispute. The sublibrary preferably also provides written commentary and a video presentation concerning mediation agreements. The Filing a Request sublibrary, as shown in FIG. 28, provides access to a form request for mediation 56, as shown in FIG. 29, that a user may employ to initiate mediation. The sublibrary preferably also provides written commentary and a video presentation concerning the request for mediation. The Administration Issues sublibrary, as shown in FIG. 30, provides access to information concerning location of hearings 57, as shown in FIG. 31, and access to information concerning mediation fees 58, as shown in FIG. 32. The Rules of Mediation sublibrary provides access to the mediation rules that a user may adopt to have disputes mediated through the system, as shown in FIG. 33. The sublibrary preferably also provides written commentary and a video presentation concerning the rules. The Select a Mediator sublibrary provides access to advice for selecting an mediator, as shown in FIG. 34. The sublibrary preferably also provides a video presentation concerning selection.

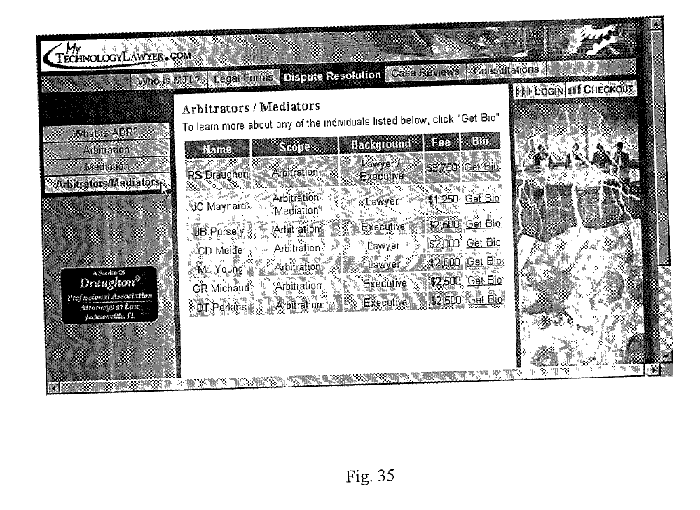

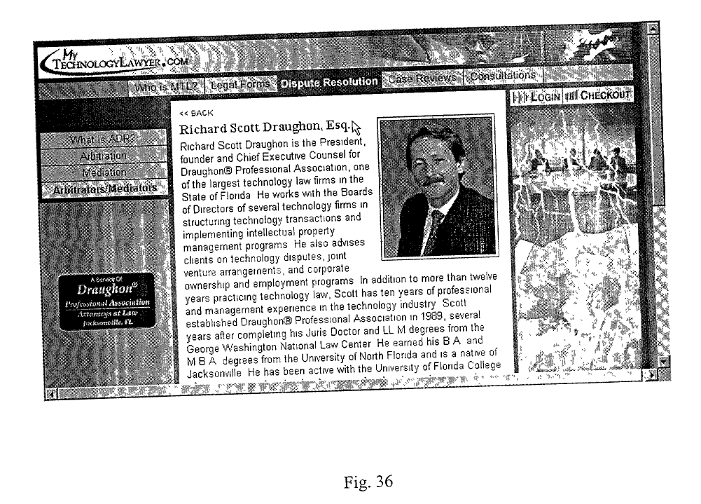

To facilitate the ADR process, the system includes an Arbitrators/Mediators library listing eligible arbitrators and mediators that parties may select to resolve their disputes, as shown in FIG. 35. This library includes fee information and a link to biographical information for each arbitrator and mediator, for example, as shown in FIG. 36. Parties may agree to resolve their disputes using the system's ADR rules and selected arbitrators or mediators.

In an alternative embodiment, the system may include an on-line ADR service. In the event of a dispute, a party may submit a demand for arbitration using an on-line template. The template would require information concerning the parties and the nature of the dispute. On-line templates would exist for all available discovery tools, such as requests for admission, requests for production of documents and interrogatories. On-line templates would also exist for all available motions, such as a motion for preliminary injunction, a motion to compel discovery, a motion to dismiss and a motion for summary judgment. Written commentary, video instructions and examples would be provided for guidance.

The dispute would be divided into discrete stages, such as discovery, testimony, evidence and brief stages. During the discovery stage, a party may solicit information and materials from other parties and witnesses using available discovery tools.

During the testimony stage, each party may elicit testimony from its witnesses using a deposition format. A party would use an on-line template to provide notice of testimony to all other parties. The notified parties will have opportunities to object. Testimony depositions may be conducted in person or remotely, via a recorded teleconference or videoconference. A party's testifying witness would be subject to cross-examination by each other party. A party may object to questions that are improper under the applicable rules, such as the U.S. Federal Rules of Evidence. Witnesses must generally answer objectionable questions, subject to any objection raised. In the event the parties reach an impasse during a testimony session, the parties may submit the issue for resolution by the arbitrators assigned to the case using a Testimony Objection template. Any party may submit any testimony transcript to the arbitration panel, provided that each party has received a copy of the transcript and has had an opportunity to object to inaccuracies and errors.

During the evidence stage, evidence is made of record by submitting a notice of reliance (using a template) and a copy of the evidence. Each party will receive a copy of each notice of reliance filed. Evidence may include scanned documents, affidavits, testimony transcripts and photographs. Each party, except the submitting party, will have an opportunity to object to the admissibility of the evidence under applicable rules of evidence, such as the U.S. Federal Rules of Evidence.

After the close of the testimony and evidence stages, the parties may submit briefs advancing legal and factual arguments based upon supporting evidence made of record and admissible testimony from submitted testimony transcripts. Arbitrators would consider the briefs, evidence and testimony in rendering a decision. The decision would be emailed to the parties.

The dispute could be resolved entirely on-line. Alternatively, it could involve in-person meetings with the arbitrators or mediators, teleconferences or videoconferences. As a user-friendly tool, the system's on-line ADR process would help businesses and attorneys who are not career litigators to efficiently and privately litigate disputes, without the pressures and publicity of a court trial.

Often parties will want to evaluate their options, costs, liability exposure and chances of success, before a legal proceeding has been initiated, during a legal proceeding, or before appealing a decision. An objective evaluation of a case by an experienced attorney may influence a party to consider settlement or forgo further legal proceedings. In such situations, users may need case review services.

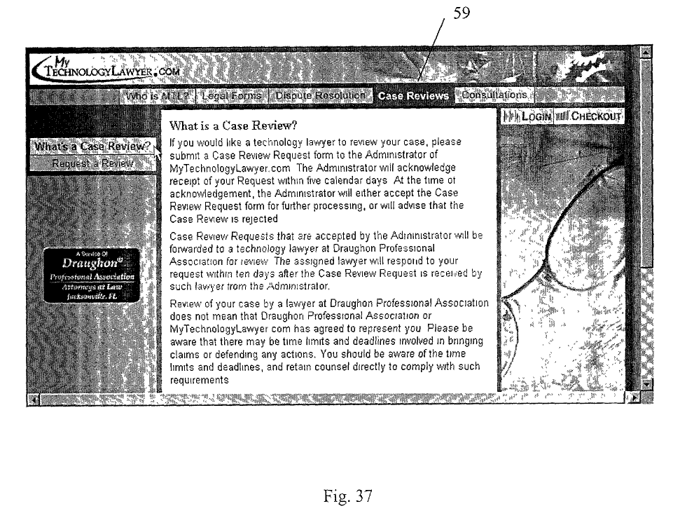

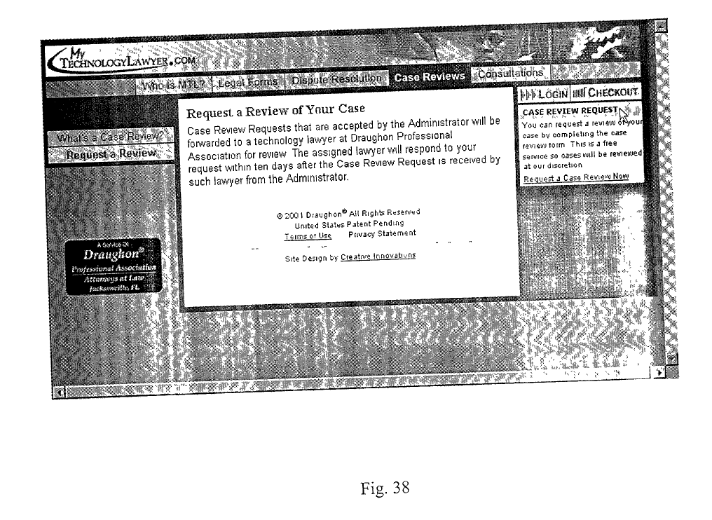

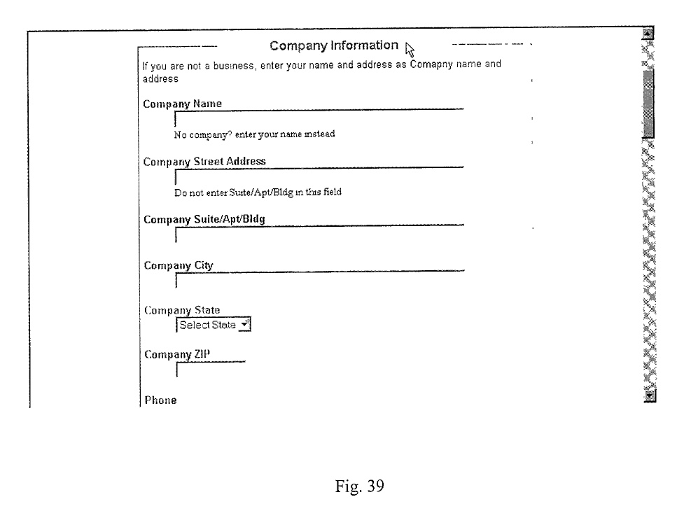

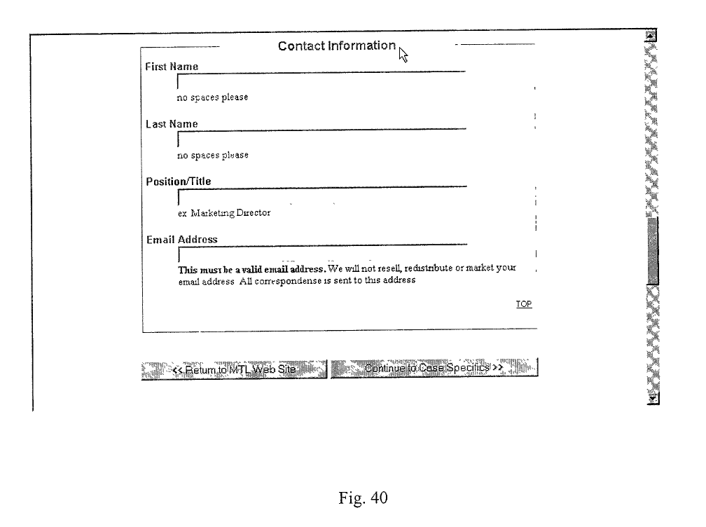

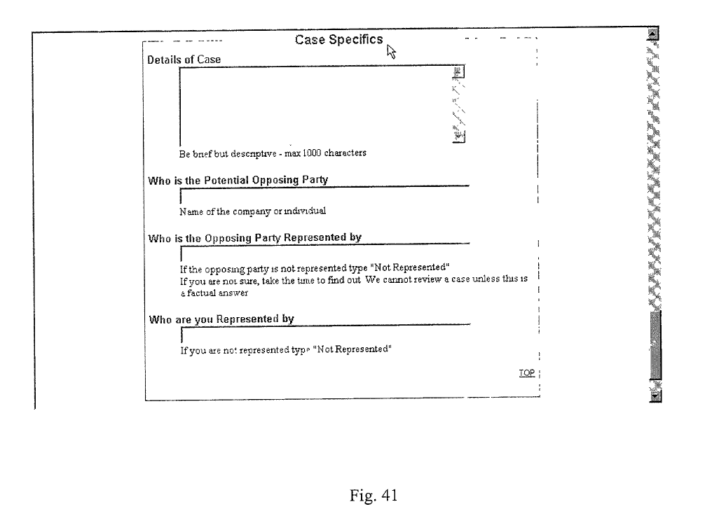

The Case Reviews section, accessed by selecting a corresponding link such as the tab 59 shown at the top of FIG. 37, includes an overview of the case review process and access to template for a user to submit a case for review as shown in FIGS. 38-41. A user may submit a Case Review Request, using the template as shown in FIG. 39-41, to an administrator of the website. The Case Review Request form requires information concerning the user, the opponent and the dispute. The administrator may accept the Case Review Request form for further processing, or reject the Case Review Request. Should the administrator accept the Case Review Request form for further processing, the administrator will refer the Case Review Request to an attorney having experience in the relevant area of law. The attorney may request additional information from the user, if necessary, review the information and Case Review Request, outline the user's options, provide a cost estimate and gauge the user's chances of success.

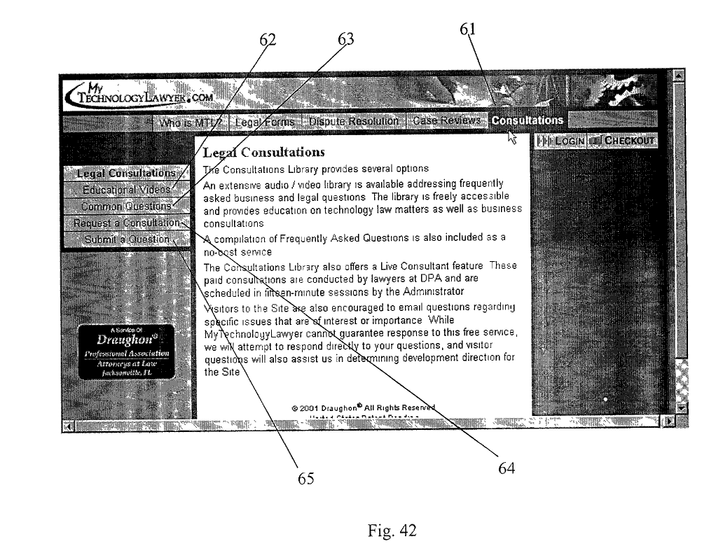

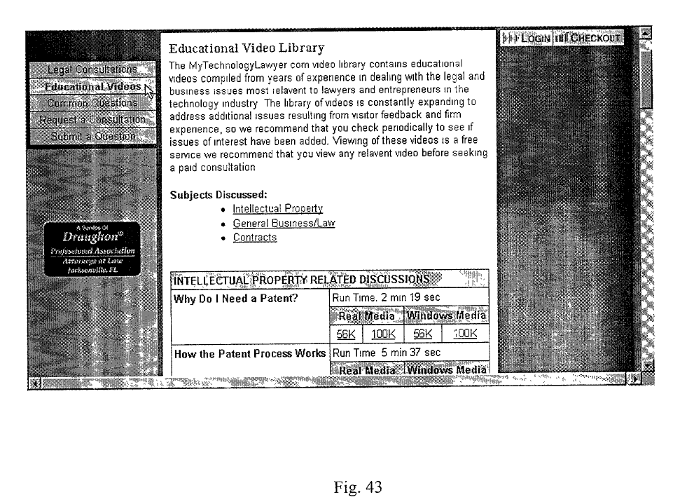

The Consultations section, accessed by selecting a corresponding link such as the tab 61 shown at the top of FIG. 42, provides access to the following libraries: Educational Videos 62, Common Questions 63, Request a Consultation 64, Submit a Question 65. The Educational Videos library 62 contains educational videos dealing with legal and business issues most relevant to users targeted by the system, as shown in FIG. 43. For example, the Educational Videos library may contain video presentations addressing “What is Software Escrow?” and “What does Work Made for Hire Mean?”. Users may access an educational video by selecting the corresponding link.

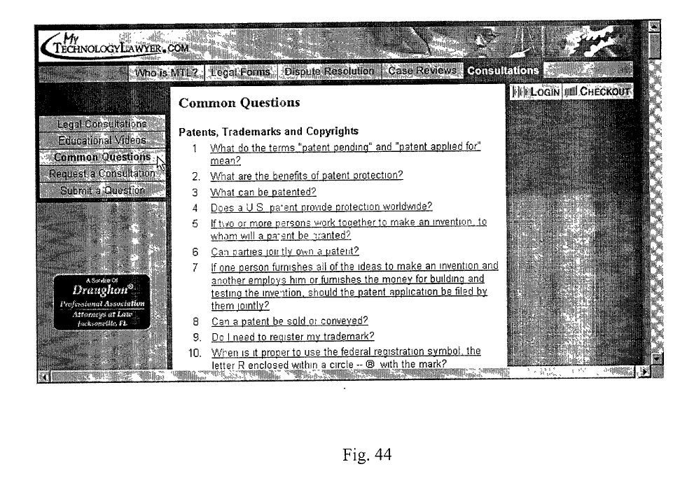

The Common Questions library contains a compilation of frequently asked questions (FAQs), as shown in FIG. 44, with links to answers. The FAQs include questions concerning legal and business issues most relevant to users targeted by the system. For example, the FAQs may contain answers to the following questions “Does a U.S. Patent Provide Protection Worldwide?” and “How Long Does Copyright Protection Last?”. Users may access a question and answer by selecting the corresponding link.

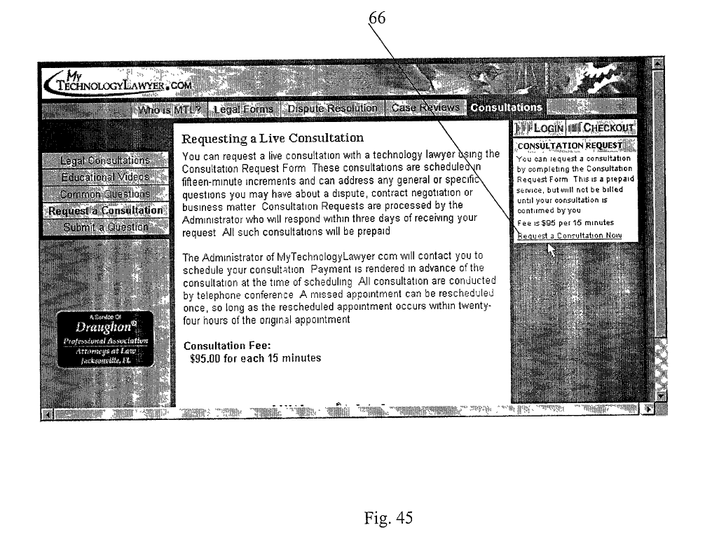

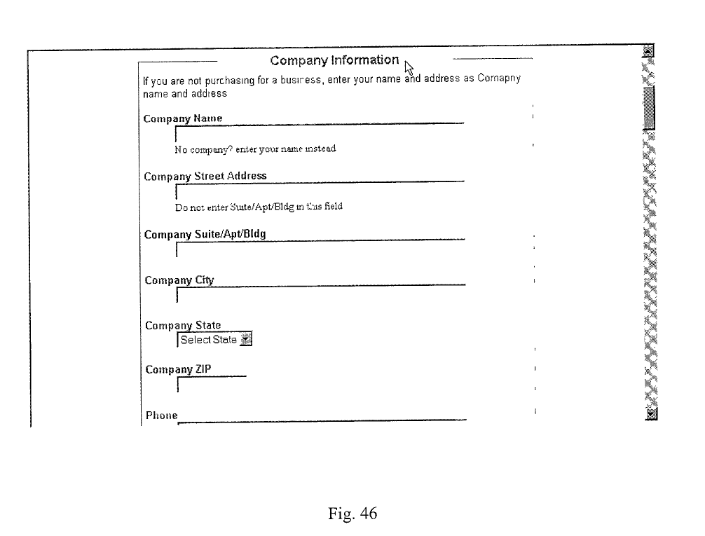

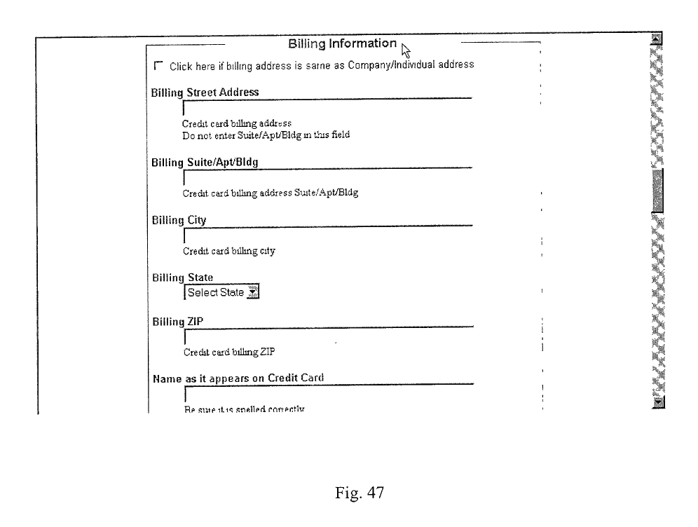

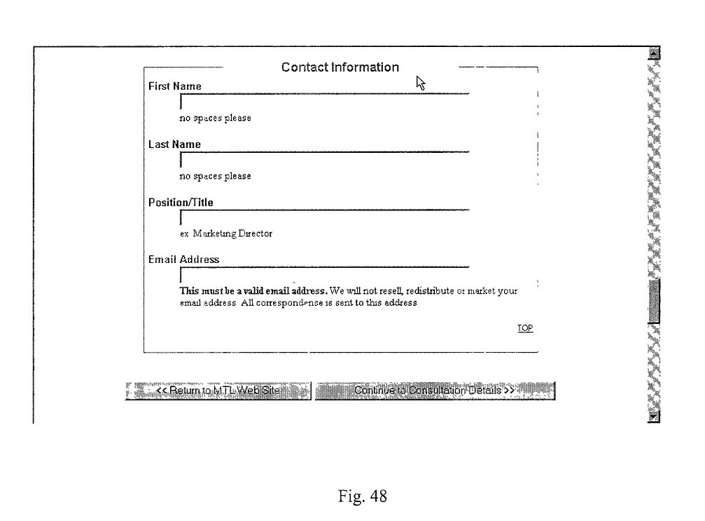

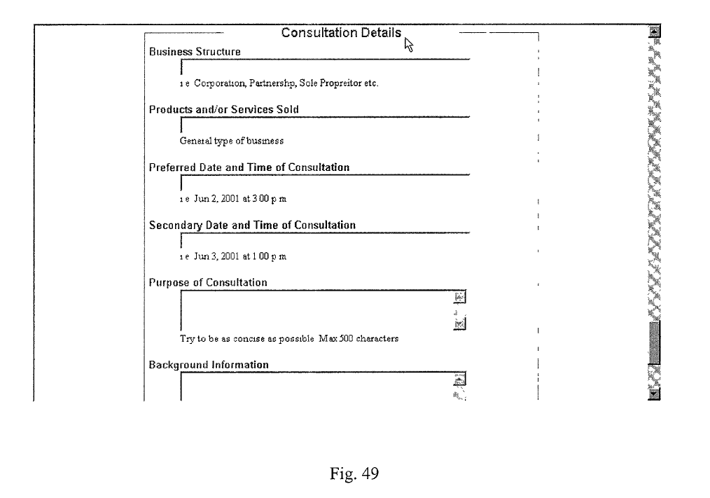

The Request a Consultation library provides access to a template 66, i.e., a Consultation Request Form, for a user to request a live consultation with a lawyer, as shown in FIG. 45. The Consultation Request Form, as shown in FIGS. 46-49, requires information concerning the user, the purpose of the consultation and background information. The consultation may be scheduled in blocks of time, e.g. fifteen-minute increments, and can address any general or specific questions a user may have about a dispute, contract, business matter or legal matter. The website may charge a fee for consultations. By providing complete and accurate background information and a detailed description of the issues, a user may efficiently obtain a focused consultation without any billing surprises.

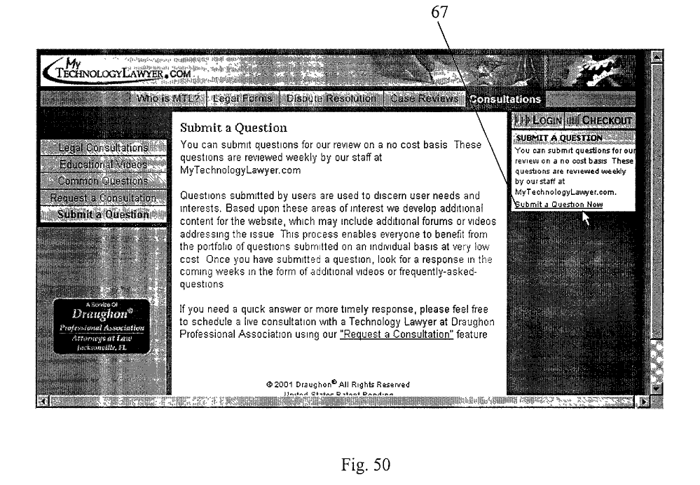

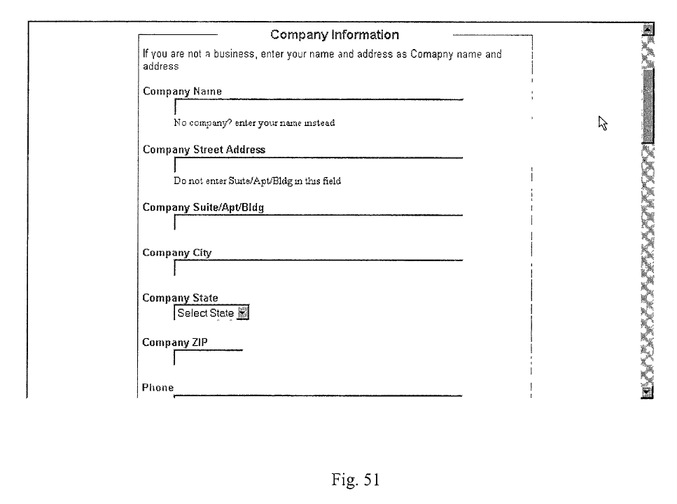

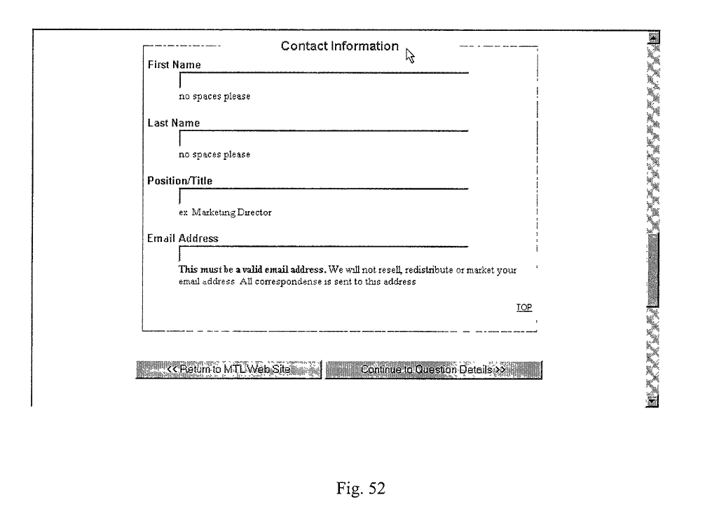

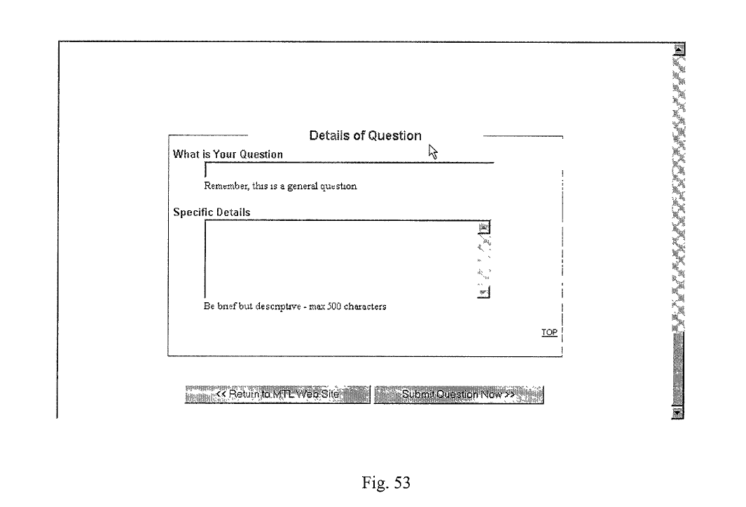

The Submit a Question library provides access to a template 67, i.e., a Submit a Question form, for a user to submit a question for answer by a lawyer, as shown in FIG. 50. The answer may be posted as an answer to an FAQ in the Common Questions library or as an educational video in the Educational Videos library. The Submit a Question form, as shown in FIGS. 51-53, requires information concerning the user, the question and pertinent details. The website may answer such questions free of charge. By providing a clearly worded question and complete and accurate details, a user may obtain valuable legal advice at no charge.

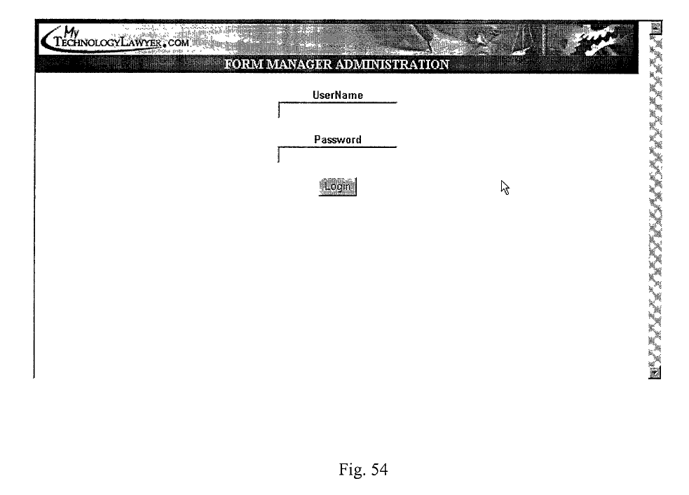

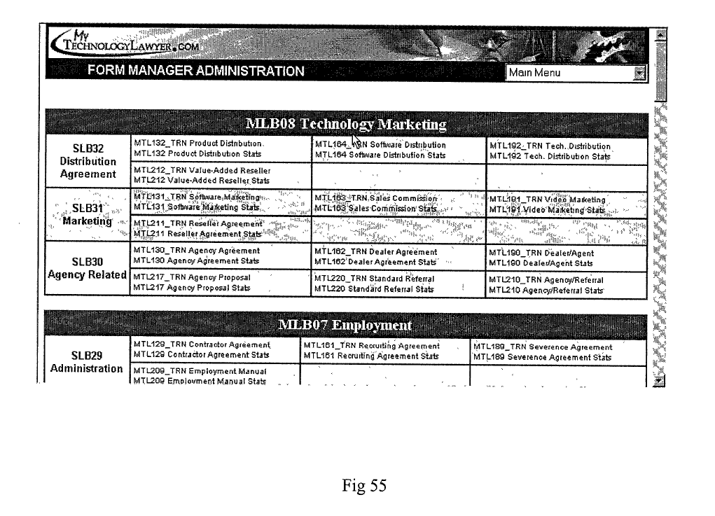

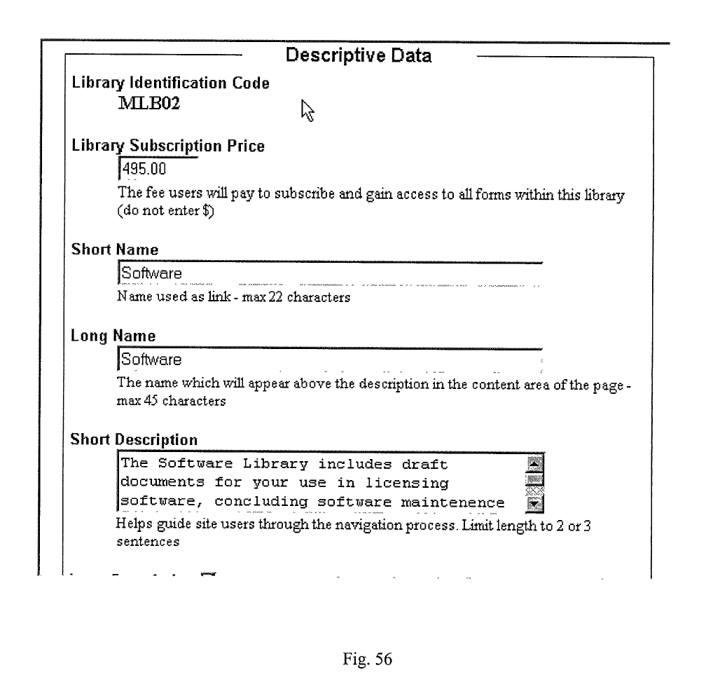

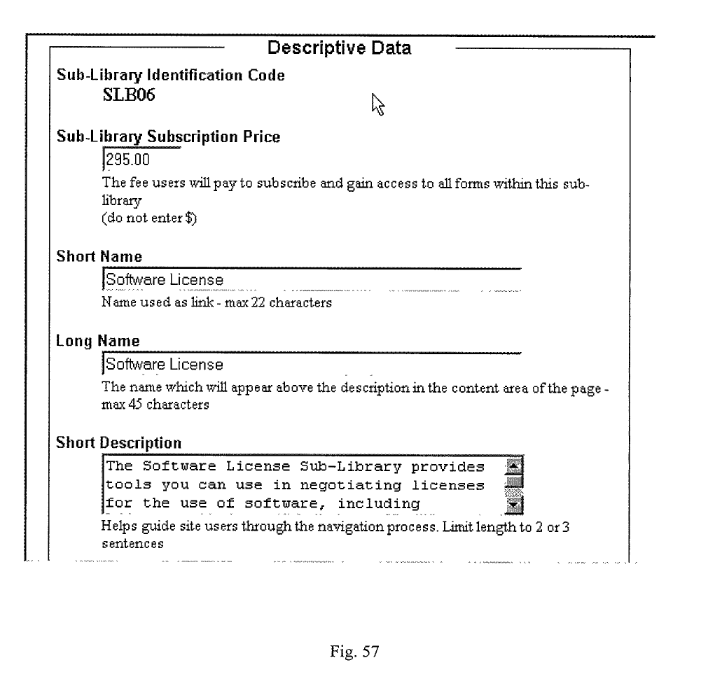

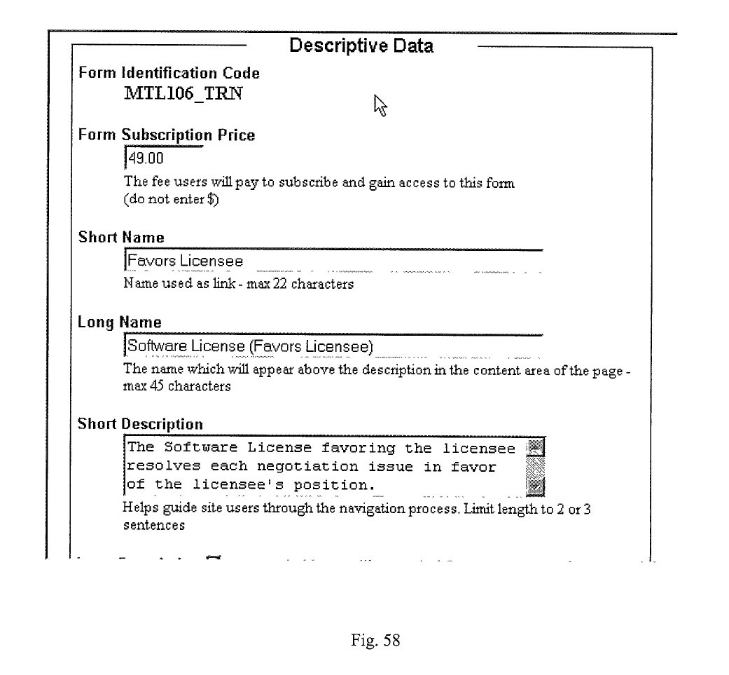

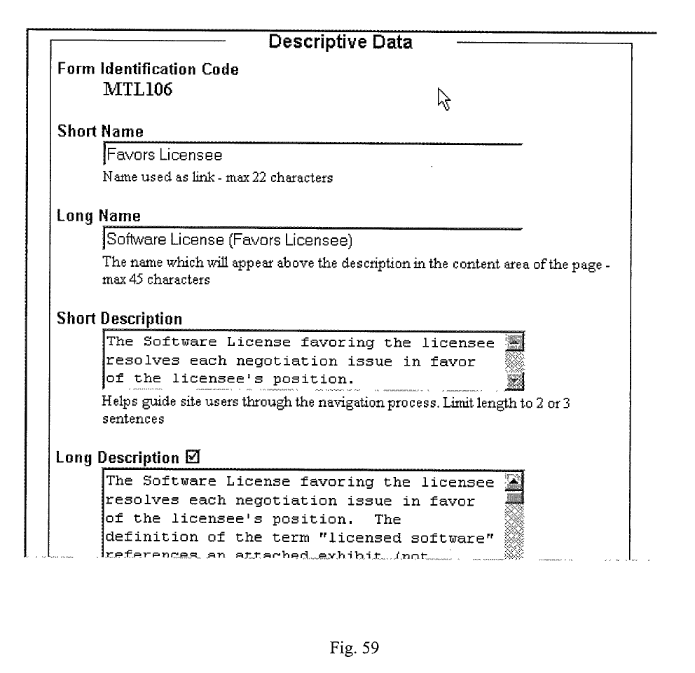

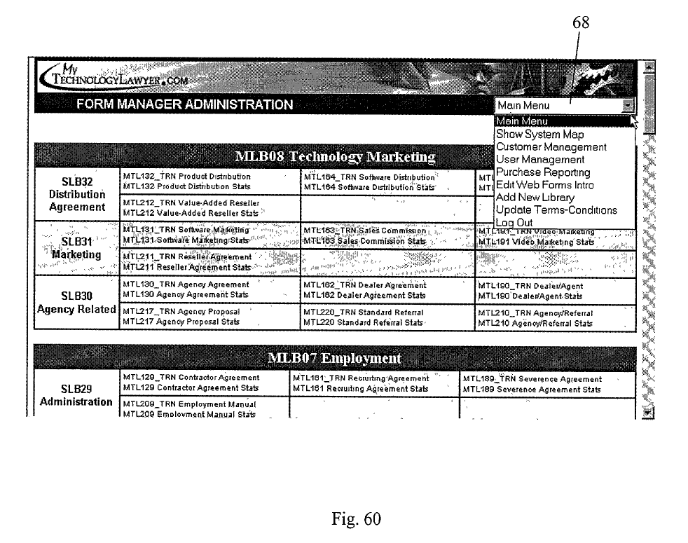

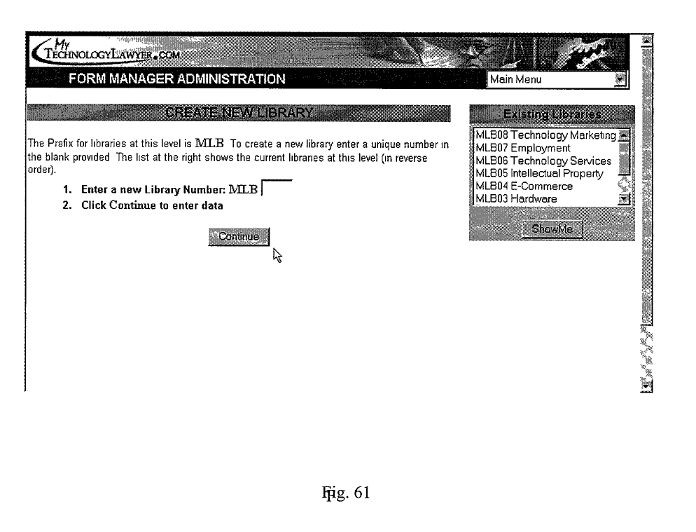

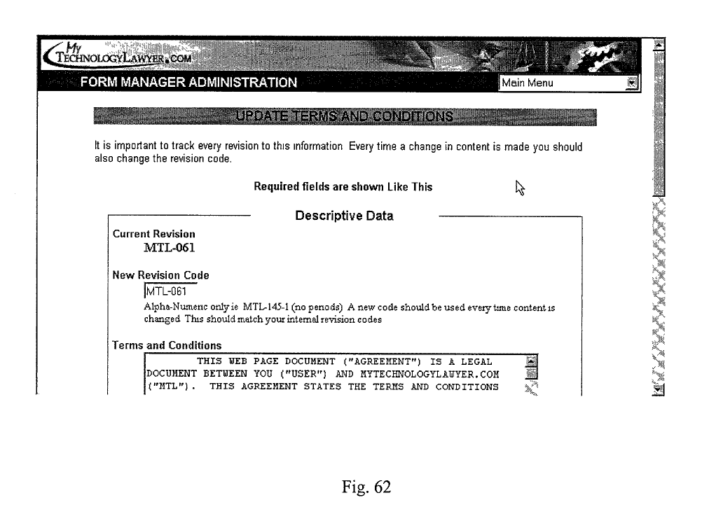

The system also preferably includes an array of administrative tools, including templates to facilitate editing libraries FIGS. 56, 61, sub-libraries FIG. 57, forms FIGS. 58, 59 and the terms and conditions for user purchases FIG. 62; tools for managing client information; and a system map FIG. 55. Preferably, a website administrator may access the administrative tools through an unpublished password-protected web page, as shown in FIG. 54. A menu of links 68 may provide access to the various administrative tools and features within the tools, as shown in FIG. 60.

Customer management tools may include a list of customers and their contacts, with links to more detailed information, such as the libraries and sublibraries to which they subscribe and the expiration dates of their subscriptions.

The foregoing description of the invention refers to specific pricing options and arrangements of various sections, libraries, sublibraries, videos, forms and content in the area of Technology Law, as examples of a preferred embodiment. Other areas of law may be covered without departing from the scope of the subject invention. Additionally, other pricing options, arrangements, sections, libraries, sublibraries, videos, forms and content may be used without departing from the scope of the subject invention. The scope of the present invention will become better understood with reference to the following claims.

What is claimed is:

1. A system for rendering legal services on-line, said system comprising:
a. means for providing legal forms on-line;
b. means for providing instructional videos on-line for the legal forms; and
c. means for providing written information on-line concerning the legal forms.

2. The system according to claim 1, said system further comprising means for providing statistics on-line concerning said legal forms, each of said legal forms having a certain number of words, variables, sections, definitions, and pages, said statistics comprising one or more of the following:
a. the number of words in the legal form;
b. the number of variables in the legal form;
C. the number of sections in the legal form;
d. the number of definitions in the legal form; and
e. the number of pages in the legal form.

3. The system according to claim 1, said system further comprising a template for adding to the system, on-line, a new legal form, an instructional video for the new legal form and written information concerning the new legal form.

4. The system according to claim 1, said system further comprising:
a. means for enabling a subscriber to access said legal forms,
b. means for providing an agreement to which the subscriber must assent before said subscriber accesses any one of said legal forms,
c. means for obtaining subscriber identification information before said subscriber accesses any one of said legal forms,
d. means for storing a copy of the agreement to which the subscriber assents, and
e. means for associating the stored copy of the agreement with the subscriber identification information.

5. The system according to claim 4, wherein the means for associating the stored copy of the agreement with the subscriber identification information further comprises:
a. an agreement version number for identifying the agreement to which the subscriber assents before said subscriber accesses any one of said legal forms,
b. means for storing a copy of the agreement version number along with the subscriber identification information for each subscriber, and

6. The system according to claim 5, said system further comprising:
a. a unique legal form name for identifying each of said legal forms;
b. means for storing a copy of the unique legal form name along with the agreement version number, subscriber identification information and legal form name for each of said legal forms accessed by the subscriber.

7. The system according to claim 1, said system further comprising a hierarchical arrangement of libraries and sublibraries, wherein:
a. each library is accessible on-line, covers a legal topic and provides access to sublibraries, and
b. each sublibrary is accessible on-line, covers an aspect of said legal topic and provides access to other sublibraries or said legal forms.

8. The system according to claim 7, said system further comprising:
a. means for providing instructional videos on-line for the legal topic which each library covers and for the aspect of said legal topic which each sublibrary covers; and
b. means for providing written information on-line for the legal topic which each library covers and for the aspect of said legal topic which each sublibrary covers.

9. The system according to claim 8, said system further comprising a template for adding to the system, on-line, one or more of the flowing:
a. a new legal form,
b. a new instructional video,
c. a new library,
d. a new sublibrary,
e. new written information concerning any one of said legal forms or a new legal form, and
f. new written information concerning any one of said libraries or a new library.

10. The system according to claim 8, said system further comprising on-line purchasing means, said on-line purchasing means comprising one or more of the following:
a. means for purchasing a legal form on-line,
b. means for purchasing a subscription to a library on-line, and
c. means for purchasing a subscription to a sublibrary on-line.

11. The system according to claim 1, said system further comprising an on-line template for requesting a legal consultation.

12. The system according to claim 1, said system further comprising an on-line template for requesting an answer to a legal question.

13. The system according to claim 1, said system further comprising an on-line list of questions concerning subject matter related to the legal forms and answers to the questions.

14. The system according to claim 1, said system further comprising a library of educational videos accessible on-line concerning subject matter related to the legal forms.

15. The system according to claim 1, said system further comprising an on-line template for requesting a case review.

16. The system according to claim 1, said system further comprising:
a. means for providing statistics on-line concerning said legal forms, each of said legal forms having a certain number of words, variables, sections, definitions, and pages, said statistics comprising one or more of the following:
(1) the number of words in the legal form,
(2) the number of variables in the legal form,
(3) the number of sections in the legal form,
(4) the number of definitions in the legal form, and
(5) the number of pages in the legal form;
b. a template for adding to the system, on-line, a new legal form, an instructional video for the new legal form and written information concerning the new legal form;
c. means for enabling a subscriber to access said legal forms;
d. means for providing an agreement to which the subscriber must assent before said subscriber accesses any one of said legal forms;
e. means for obtaining subscriber identification information before said subscriber accesses any one of said legal forms;
f. means for storing a copy of the agreement to which the subscriber assents;
g. an agreement version number for identifying the agreement to which the subscriber assents before said subscriber accesses any one of said legal forms;
h. means for storing a copy of the agreement version number along with the subscriber identification information for each subscriber;
i. a unique legal form name for identifying each of said legal forms;
j. means for storing a copy of the unique legal form name along with the agreement version number, subscriber identification information and legal form name for each of said legal forms accessed by the subscriber;
k. a hierarchical arrangement of libraries and sublibraries, wherein:
(1) each library is accessible on-line, covers a legal topic and provides access to sublibraries, and
(2) each sublibrary is accessible on-line, covers an aspect of said legal topic and provides access to other sublibraries or said legal forms;
l. means for providing instructional videos on-line for the legal topic that each library covers and for the aspect of said legal topic that each sublibrary covers;
m. means for providing written information on-line for the legal topic that each library covers and for the aspect of said legal topic that each sublibrary covers;
n. a template for adding to the system, on-line, one or more of the flowing:
(1) a new legal form,
(2) a new instructional video,
(3) a new library,
(4) a new sublibrary,
(5) new written information concerning any one of said legal forms or a new legal form, and
(6) new written information concerning any one of said libraries or a new library;
o. on-line purchasing means, said on-line purchasing means comprising one or more of the following:
(1) means for purchasing a legal form on-line,
(2) means for purchasing a subscription to a library on-line, and
(3) means for purchasing a subscription to a sublibrary on-line;
p. an on-line template for requesting a legal consultation;
q. an on-line template for requesting an answer to a legal question;
r. an on-line list of questions concerning subject matter related to the legal forms and answers to the questions;
s. a library of educational videos accessible on-line concerning subject matter related to the legal forms; and
t. an on-line template for requesting a case review.

17. A system for rendering legal services on-line, said system comprising:
a. means for providing legal forms on-line;
b. means for providing a hierarchical arrangement of libraries and sublibraries on-line, wherein:
(1) each library covers a legal topic and provides access to sublibraries, and
(2) each sublibrary covers an aspect of said legal topic and provides access to other sublibraries or said legal forms;
c. means for providing instructional videos on-line for one or more of the following:
(1) the legal forms,
(2) the legal topic that each library covers,
(3) the aspect of said legal topic that each sublibrary covers; and
d. means for providing written information on-line concerning one or more of the following:
(1) the legal forms,
(2) the legal topic that each library covers, and
(3) the aspect of said legal topic that each sublibrary covers.

18. A method for rendering legal services on-line, said method comprising the steps of:
a. providing legal forms on-line;
b. providing a hierarchical arrangement of libraries and sublibraries on-line, wherein:
(1) each library covers a legal topic and provides access to sublibraries, and
(2) each sublibrary covers an aspect of said legal topic and provides access to other sublibraries or said legal forms;
c. providing instructional videos on-line for one or more of the following:
(1) the legal forms,
(2) the legal topic which each library covers, and
(3) the aspect of said legal topic which each sublibrary covers; and
d. providing written information on-line concerning one or more of the following:
(1) the legal forms,
(2) the legal topic which each library covers, and
(3) the aspect of said legal topic which each sublibrary covers.

19. The method according to claim 18, said method further comprising one or more of the following steps:
a. providing an on-line template for requesting a legal consultation,
b. providing an on-line template for requesting a case review,
c. providing an on-line template for requesting an answer to a legal question,
d. providing an on-line list of questions concerning subject matter related to the legal forms and answers to the questions, and
e. providing a library of educational videos accessible on-line concerning subject matter related to the legal forms.

20. The method according to claim 18, said method further comprising the step of providing dispute resolution services on-line, said dispute resolution services comprising the following steps:
a. providing information concerning dispute resolution processes;
b. providing information concerning available arbitrators and mediators; and
c. providing legal forms for initiating arbitration or mediation.
